(19) United States
(12) Patent Application Publication
(10) Pub. No.: US 2024/0213773 A1
(43) Pub. Date: Jun. 27, 2024

(54) SYSTEMS AND METHODS FOR PEAK-CLIPPING AND LOAD-SHIFTING ENERGY STORAGE DISPATCH CONTROL STRATEGIES FOR EVENT-BASED DEMAND RESPONSE

(71) Applicants: Joseph Elio, Mesa, AZ (US); Ryan Milcarek, Gilbert, AZ (US); Miguel Peinado-Guerrero, Phoenix, AZ (US); Jesus Villalobos, Mesa, AZ (US)

(72) Inventors: Joseph Elio, Mesa, AZ (US); Ryan Milcarek, Gilbert, AZ (US); Miguel Peinado-Guerrero, Phoenix, AZ (US); Jesus Villalobos, Mesa, AZ (US)

(73) Assignee: Arizona Board of Regents on Behalf of Arizona State University, Tempe, AZ (US)

(21) Appl. No.: 18/545,807

(22) Filed: Dec. 19, 2023

Related U.S. Application Data
(60) Provisional application No. 63/433,590, filed on Dec. 19, 2022.
(60) Provisional application No. 63/526,902, filed on Jul. 14, 2023.

(51) Int. Cl. H02J 3/00; H02J 3/32

(52) U.S. Cl. CPC H02J 3/003; H02J 3/32; H02J 2203/10; H02J 2203/20; H02J 2310/60; H02J 2310/64

(57) ABSTRACT

A system applies optimal peak-clipping (PC) and load-shifting (LS) control strategies of a Li-ion BESS at a large industrial facility with and without enrollment in the electrical utility company's event-based DR program. The optimally sized BESSs and discounted payback periods are determined for both control strategies with and without event-based DR enrollment. Additional optimization can be performed to reduce an environmental impact of using the BESS. Comparisons between the PC and LS control strategies' operations show that for the same sized Li-ion BESS with DR enrollment, the LS control strategy achieves more revenue in DR events and by leveraging the energy-price arbitrage.

### CROSS-REFERENCE TO RELATED APPLICATIONS

This is a U.S. Non-Provisional Patent Application that claims benefit to U.S. Provisional Patent Application Ser. No. 63/433,590 filed 19 Dec. 2022 and U.S. Provisional Patent Application Ser. No. 63/526,902 filed 14 Jul. 2023, which are herein incorporated by reference in its entirety.

### GOVERNMENT SUPPORT

This invention was made with government support under DE-EE0007721 awarded by the U.S. Department of Energy. The government has certain rights in the invention.

### FIELD

The present disclosure generally relates to energy distribution and control strategies, and in particular, to a system and associated methods for energy storage dispatch control for event-based demand response using peak-clipping and load-shifting.

### BACKGROUND

Increasing electricity demand and an aging infrastructure are resulting is several indicators of a less reliable power supply in the U.S. Global electricity demand increased over 6% from 2020 to 2021, the highest increase occurring since the recovery from the financial crisis in 2010. A large contributor to the increase in electricity demand is due to buildings, as they consumed around 25% of U.S. electricity in the 1950s, 40% in the early 1970s, and more than 76% in 2012. The existing electrical power grid's infrastructure is not adequately designed to accommodate for this escalating electric consumption trend, or the resulting peak power demand, thereby increasing the risk of blackouts. Furthermore, the escalation in electrical energy consumption, without a similar increase in supply capacity, also increases the risk of blackouts. Historically, electricity generation has followed consumption, but future projections suggest a fundamental shift in the paradigm is necessary to ensure electrical consumption follows generation. The need for this shift is becoming increasingly apparent since utilities are not investing sufficiently in modernization of the aged infrastructure that has far surpassed its useful life span. As such, demand response (DR) programs in utility companies may become more prevalent to ensure that electricity consumption better follows generation.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a simplified diagram showing an exemplary computing system for implementation of an energy storage dispatch optimization model;

FIG. 1B is a simplified diagram showing an optimization flow for implementation by the computing system of FIG. 1A;

FIG. 2 is a graphical representation showing a time-of-use energy usage rate structure;

FIG. 3 is a graphical representation showing an intermittent process facility's average demand on each day;

FIG. 4 is a graphical representation showing a continuous process facility's average demand on each day;

FIG. 5 is a graphical representation showing lithium-ion ϵ vs. energy storage capacity for the intermittent process facility profile;

FIGS. 6A and 6B are a pair of graphical representations showing an intermittent process facility profile using 180 kW/900 kWh lithium-ion battery energy storage, where FIG. 6A shows a second day and FIG. 6B shows a day with maximum power demand;

FIG. 7 is a graphical representation showing an intermittent process facility profile using 180 kW/900 kWh lithium-ion battery energy storage throughout a full month;

FIG. 8 is a graphical representation showing supercapacitor E vs. energy storage capacity for the intermittent process facility profile;

FIGS. 9A and 9B are a pair of graphical representations showing an intermittent process facility profile using 100 kW/100 kWh supercapacitor energy storage, where FIG. 9A shows a second day and FIG. 9B shows a day with maximum power demand;

FIG. 10 is a graphical representation showing an intermittent process facility profile using 100 kW/100 kWh supercapacitor energy storage throughout a full month;

FIG. 11 is a graphical representation showing compressed air ES ϵ vs. energy storage capacity for the intermittent process facility profile;

FIGS. 12A and 12B are a pair of graphical representations showing an intermittent process facility profile using 333.3 kW/5000 kWh compressed air energy storage, where FIG. 12A shows a second day and FIG. 12B shows a day with maximum power demand;

FIG. 13 is a graphical representation showing an intermittent process facility profile using 333.3 kW/5000 kWh compressed air energy storage throughout a full month;

FIG. 14 is a graphical representation showing comparison of ϵ for the intermittent (profile 1) process facility using lithium-ion, supercapacitor, and compressed air energy storage;

FIG. 15 is a graphical representation showing Lithium-ion ϵ vs. Energy Storage Capacity for the Continuous Process Facility Profile;

FIGS. 16A and 16B are a pair of graphical representations showing a continuous process facility profile using 140 kW/700 kWh lithium-ion battery energy storage, where FIG. 16A shows a second day and FIG. 16B shows a day with maximum power demand;

FIG. 17 is a graphical representation showing a continuous process facility profile using 140 kW/700 kWh lithium-ion battery energy storage throughout a full month;

FIG. 18 is a graphical representation showing supercapacitor E vs. energy storage capacity for the continuous process facility profile;

FIGS. 19A and 19B are a pair of graphical representations showing a continuous process facility profile using 100 kW/100 kWh supercapacitor energy storage, where FIG. 19A shows a second day and FIG. 19B shows a day with maximum power demand;

FIG. 20 is a graphical representation showing continuous process facility profile using 100 kW/100 kWh supercapacitor energy storage throughout a full month;

FIG. 21 is a graphical representation showing compressed air ϵ vs. E energy storage capacity for the continuous process facility profile;

FIGS. 22A and 22B are a pair of graphical representations showing a continuous process facility profile using 166.7 kW/2500 kWh compressed air energy storage, where FIG. 22A shows a second day and FIG. 22B shows a day with maximum power demand;

FIG. 23 is a graphical representation showing a continuous process facility profile using 166.7 kW/2500 kWh compressed air energy storage throughout a full month; and

FIG. 24 is a graphical representation showing comparison of E for the intermittent (profile 1) and continuous (profile 2) process facilities using lithium-ion, supercapacitor, and compressed air energy storage.

FIG. 25 is a graphical representation showing variation in E for different energy storage capacities and discharge times (DTs) of a Li-ion battery energy storage system under both peak clipping and load shifting control strategies without DR enrollment;

FIGS. 26A and 26B are a pair of graphical representations showing variation in energy storage system costs (capital and operation and maintenance (O&M)) and savings (usage, demand, and total) as a function of Li-ion battery energy storage capacity with an 8 h discharge time without DR enrollment under peak clipping control and load shifting control, respectively;

FIG. 27 is a graphical representation showing variation in E for different energy storage capacities and discharge times (DTs) of a Li-ion battery energy storage system under both peak clipping and load shifting control strategies with DR enrollment;

FIGS. 28A and 28B are a pair of graphical representations showing variation in energy storage system costs (capital and operation and maintenance (O&M)) and savings (usage, demand, and total) as a function of Li-ion battery energy storage capacity with an 8 h discharge time with DR enrollment under peak clipping control and load shifting control, respectively;

FIGS. 29A-29D are a series of graphical representations showing an original demand profile and new demand profile (without DR enrollment) on the first August day with a DR event after optimal control of a 1,250 kW/5,000 kWh Li-ion BES for PC control strategy (FIG. 29A), LS control strategy (FIG. 29B), Li-ion BES inventory and TOU rate plan pricing for PC control strategy (FIG. 29C) and LS control strategy (FIG. 29D);

FIGS. 30A-30D are a series of graphical representations showing an original demand profile and new demand profile (with DR enrollment) on the first August day with a DR event after optimal control of a 1,250 kW/5,000 kWh Li-ion BES for PC control strategy (FIG. 30A), LS control strategy (FIG. 30B), Li-ion BES inventory and TOU rate plan pricing for PC control strategy (FIG. 30C) and LS control strategy (FIG. 30D);

FIG. 31 is a graphical representation showing TCS during each month of operation for the optimally sized Li-ion BESSs under the PC and LS control strategies with and without event-based DR enrollment;

FIG. 32 is a graphical representation showing TCS during each month of operation for the optimally sized Li-ion BESS (1,155 kW/9,237 kWh) under LS control with DR enrollment for varying rates of inflation: −0.4%, 1.76% (original value), 3.8%, and 13.5%;

FIG. 33 is a graphical representation showing TCS during each month of operation for the optimally sized Li-ion BESS (1,155 kW/9,237 kWh) under LS control with DR enrollment for varying rates of utility cost increases: −2.68%, 0.53%, 3.9% (original value), and 7.65%;

FIG. 34 is a graphical representation showing TCS as a function of month of operation for optimally sized Li-ion BESS (1,155 kW/9,237 kWh) under LS control with DR enrollment for varying rates of operation and maintenance cost increases: 0%, 3% (original value), and 6%;

FIG. 35 is a graphical representation showing maximum annual demand and total annual electricity consumption for each of the ten commercial and industrial facilities based on 2021 utility data;

FIGS. 36A and 36B are a pair of graphical representations showing optimal ES capacity and power output in each of the ten commercial and industrial facilities for minimizing discounted payback period (DPP) (FIG. 36A) and maximizing CO₂ savings (FIG. 36B);

FIG. 37 is a graphical representation showing variation in discounted payback period with optimal ES capacity based on results from the ten commercial and industrial facilities;

FIGS. 38A and 38B are a pair of graphical representations showing impact of event-based DR enrollment utilizing the optimally sized BESS under the optimal control strategy on discounted payback period (FIG. 38A) and percentage of indirect CO₂ emissions saved for each of the ten commercial and industrial facilities in 2021 and maximizing CO₂ savings (FIG. 38B);

FIGS. 39A and 39B are a pair of graphical representations showing impact of dispatch strategy (peak clipping or load shifting) utilizing the optimally sized BESS with enrollment in event-based DR on discounted payback period (FIG. 39A) and percentage of indirect CO₂ emissions saved for each of the ten commercial and industrial facilities in 2021 (FIG. 39B);

FIGS. 40A and 40B are a pair of graphical representations showing impact of discharge time (DT) with the optimal capacity BESS under load shifting control with enrollment in event-based DR on discounted payback period (FIG. 40A) and percentage of indirect CO₂ emissions saved for each of the ten commercial and industrial facilities in 2021 (FIG. 40B);

FIGS. 41A-41D are a series of graphical representations showing operation of a 960 kW/9,600 kWh Li-ion BESS on Commercial #1 facility on an August day with a DR event, with FIG. 41A showing the original and new demand profiles after multi-objective cost and CO₂ savings optimization, FIG. 41B showing the original and new demand profiles after cost objective optimization, FIG. 41C shows the ES inventory and time-of-use (TOU) pricing after multi-objective cost and CO₂ savings optimization, and FIG. 41D shows the ES inventory and time-of-use (TOU) pricing after cost objective optimization; and

FIGS. 42A and 42B are a pair of graphical representations showing change in ES inventory of the 960 kW/9,600 kWh Li-ion BESS on Commercial #1 facility and the electrical power grid's MEF on an August day with a DR event after the multi-objective cost and CO₂ savings optimization (FIG. 42A) and cost objective optimization (FIG. 42B).

Corresponding reference characters indicate corresponding elements among the view of the drawings. The headings used in the figures do not limit the scope of the claims.

### DETAILED DESCRIPTION

The intervals in which a facility pulls power from a local grid is very important, not just in terms of saving money but also to avoid overloading the local grid which needs to service the public. “Hogging” power during “on-peak” hours is not a sustainable practice, and may in some cases be detrimental to locals who depend on power at peak times to run their businesses and power their homes. Implementing energy storage systems can help facilities balance their on-peak/off-peak resource consumption to reduce the negative impact that can result from pulling power from the grid during peak hours. However, the perceived spatial, monetary, convenience, and human resource costs of implementing energy storage systems can be prohibitive and may dissuade facility operators from adopting energy storage systems. Many facility operators are unsure of what using an energy storage system may entail in terms of system lifetime, expected operation and maintenance, space consumption, and optimal configurations. As such, the systems outlined herein are directed to optimizing time-dependent resource consumption and usage schemes for a facility across different types and configurations of energy storage systems and in view of their power demand data.

In some examples, time-dependent resource consumption may be conveniently evaluated in terms of “costs”, which can include factors such as time, effort, money, and environmental impact. Various “costs” as outlined herein can pertain to relative estimates of human resources such as time and effort and/or estimates of wear-and-tear on the energy storage system. For example, both may be considered as part of “operation and maintenance” which may be undertaken by employees of a facility and may be valued at least in part by device efficiency and lifetime. Additionally, “costs” as outlined herein can also encompass a relative environmental impact, such as those associated with CO₂ emissions which may be reduced with usage of the energy storage system. In a further aspect, “costs” as outlined herein can also encompass monetary values in addition to human resources, such as those associated with up-front costs of purchase and installation and/or continued operation and maintenance (e.g., in terms of time, parts, and labor) of an energy storage system.

To ensure that different types of costs (e.g., time, physical space, effort/labor, environmental impact, and monetary) and the comparison therebetween can be jointly and universally considered, some parts of the present disclosure arbitrarily merge the different types of costs by calculating various types of cost (even those which are non-monetary) in terms of a monetary value. However, this is merely a convenient way to represent the general costs and relative “savings” of adopting an energy storage system and should not limit the scope of the invention to monetary costs. More generally, the “costs” may be considered as factors that can be translated or otherwise to any other type of measure.

### 1. General Overview

Various embodiments of a system and associated methods for energy storage optimization are outlined herein. The system uses power demand data for a facility to optimize various aspects of a battery energy storage system (BESS) based on the power demand data. In particular, the system can access power demand data for a facility, the power demand data representing original power demand values over a plurality of power demand intervals (e.g., an original power demand profile), and optimizes a charge-discharge profile of a Battery Energy Storage System (BESS) that results in minimization of a total cost factor over the plurality of power demand intervals. To optimize the charge-discharge profile, the system can vary parameters of the charge-discharge profile and determine the total cost factor that would be expected for the facility if the facility were to implement the BESS under the charge-discharge profile. For each charge-discharge profile, the optimization can be carried out based on comparison between a new demand value and the original demand value for each respective power demand interval of the plurality of power demand intervals.

As noted, the total cost factor can encompass, for example, an environmental cost factor under the charge-discharge profile of the BESS that quantifies an environmental impact of using the BESS. The total cost factor can further incorporate an electricity consumption cost factor in terms of the new demand value under the charge-discharge profile of the BESS, a demand cost factor that quantifies an expected utility cost associated with the new demand value under the charge-discharge profile of the BESS, and a BESS usage cost factor of using the BESS under the charge-discharge profile of the BESS that quantifies expected degradation of the BESS over time. In a further aspect, the total cost factor can incorporate a demand response factor that quantifies a benefit associated with event-based demand response enrollment under the charge-discharge profile of the BESS.

The charge-discharge profile can include a set of properties of the BESS (type, capacity, load profile impact, etc.), as well as a usage scheme of the BESS that defines a charge-discharge policy of the BESS and an event-based demand response policy of the BESS.

Under some usage schemes, the BESS usage cost factor can incorporate continuous compounding over the plurality of power demand intervals to model degradation of the BESS over time. In some examples, the usage scheme can be one of: a peak-clipping policy where the BESS charges during intervals when the original demand value is below a charge threshold value and where the BESS discharges during intervals when the original demand value is above a discharge threshold value; and a load-shifting policy where the BESS charges during off-peak usage hours and discharges during on-peak usage hours.

Additional factors that can be evaluated by the system and considered for optimization of the charge-discharge profile can include a total cost savings factor, where the total cost savings factor quantifies a total difference between costs associated with the original power demand profile and the total cost factor under the charge-discharge profile of the BESS. The system can also determine a timeframe in which the total cost savings factor is expected to exceed a total capital cost associated with the BESS under the charge-discharge profile of the BESS over the plurality of power demand intervals.

In some embodiments, the charge-discharge profile optimized by the system can be applied to a control system that operates the BESS according to the charge-discharge profile. Further, the system can display, at a display device in communication with a processor, a graphical representation representing the total cost factor.

### 2. Computer-Implemented System

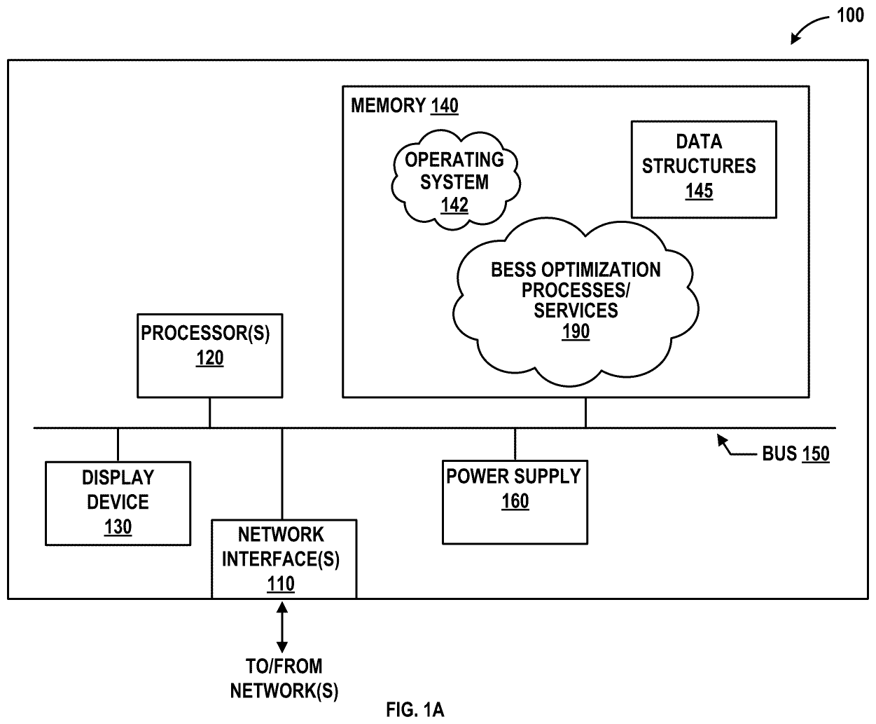

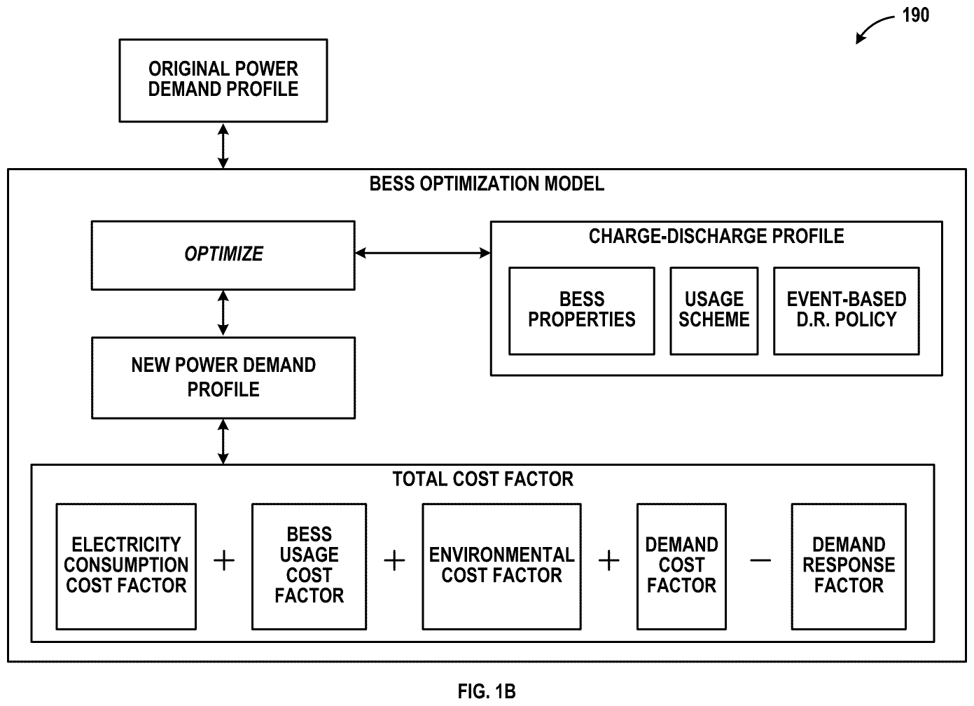

FIG. 1A is a schematic block diagram of an example system 100 that may be used with one or more embodiments described herein, e.g., as a component of a computer-implemented system for energy storage dispatch optimization of BESSs.

System 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.). Further, system 100 can include a display device 130 that displays information to a user, including graphical representations and text showing various metrics outlined herein such as total cost factor and information about the charge-discharge profile.

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, system 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the system and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes system 100 by, inter alia, invoking operations in support of software processes and/or services executing on the device. These software processes and/or services may include ES optimization processes/services 190, which can include aspects of methods described herein and/or implementations of various modules described herein. Note that while BESS Profile Optimization processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the BESS Profile Optimization processes/services 190 is shown as a standalone process, those skilled in the art will appreciate that this process may be executed as a routine or module within other processes.

The system 100 applies an optimization model (e.g., BESS Profile Optimization processes/services 190) that minimizes energy costs for a single facility using a job-shop scheduling problem formulation. In the model, production shifting and ES were considered to minimize total production cost inclusive of demand and energy charges. The present disclosure provides a description of the system 100 that applies an optimization model for optimizing the usage and demand cost savings of an ESS based on a time-of-use rate structure, and subtracting the cost to the facility for discharging the device using a ‘cost of discharge’ (CoD) parameter. This CoD parameter considers the capital investment and uses continuous compounding in every 15-minute interval, enabling the system 100 to factor in an accurate estimation of the time value of money and the O&M cost increase as the ESS gets older. The optimization model varies three parameters: the size of an ESS to optimize the size for a facility, the type of ESS to identify the differences in the optimal for each technology, and the load profiles impact on the optimal size of each ESS.

### 3: Charge-Discharge Profile Optimization

FIG. 1B outlines an optimization model for maximizing the electric cost savings of the BESS using industrial demand profiles under a time-of-use rate structure. Under this rate structure, the user is billed according to two costs, energy and demand. For energy, the user is charged a rate (USD/kWh) for how much energy they use. This rate varies depending on the time of day. For the demand charge, the user is billed for the highest average demand over a 15-minute interval that occurred in the billing period, referred to as the peak power demand. Hence, savings can be obtained by either usage cost savings (UCS) and/or demand cost savings (DCS), but these savings are reduced by the previously mentioned CoD.

BESS discharge can be optimized monthly (due to peak demand charges occurring monthly and utility usage rates changing seasonally) to minimize the total utility costs of the commercial and industrial electricity consumers. Under the optimization model, the new demand in each interval t (NDₜ) is first calculated from the original demand in each interval t (Dₜ), the round trip efficiency of the Li-ion BESS (η, 91.45%), and the amount of energy discharged and charged from the BESS in each interval t (EDₜ and ECₜ, respectively). This calculation is shown in Eq. (1-1), where ECₜ is divided by η since more electricity is pulled from the grid (reflected in NDₜ) than is stored in the BESS (ECₜ).

$$N {D}_{t} = {D}_{t} - E {D}_{t} + \frac{E {C}_{t}}{η} \qquad ( 1 - 1 )$$

In some embodiments, the event-based DR savings can be considered directly in the objective function, to fully take advantage of these savings, rather than only constrain the BESS to discharge during the events. As such, the event-based DR savings (DRS) are calculated in Eq. (1-2).

$$D R S = {\sum }_{t ∈ {T}_{D R}} ( {D}_{t} - N {D}_{t} ) R {T}_{D R} + [ max ( {D}_{t} ) - max ( {ND}_{t} ) ] D {C}_{D R} ∀ {T}_{D R} ∈ m o \qquad ( 1 - 2 )$$

Where RT_{DR} is the kWh reduction incentive, DC_{DR} is the kW reduction incentive, and T_{DR} are the time intervals of the DR event(s) in the month, mo. The objective function is formulated to minimize the total utility costs, z, as shown in Eq. (1-3).

$$z = {\sum }_{t ∈ T} ( N {D}_{t} R {T}_{t} + C o {D}_{t} E {D}_{t} + N {D}_{t} M E {F}_{t} c C ) + max ( {ND}_{t} ) D C - D R S \qquad ( 1 - 3 )$$

Where RTₜ is the cost of electrical energy in time interval t, CoD is the cost of discharge parameter, and DC is the peak demand charge for the facility. The first term within the summation represents the cost of electricity consumption and the second term within the summation represents the cost of utilizing the BESS. The third term represents the “cost of carbon emissions,” calculated by multiplying the new demand, the marginal emissions factor (MEF), and social cost of carbon emissions (cC). The next term represents the demand charge, since these commercial and industrial facilities are billed based on their maximum 15-minute interval power demand in the billing period (1 month).

Modification of the CoD parameter impacts the control strategy of the Li-ion BESS. For example, lower CoD values allow for the BESS to capitalize on the energy-price arbitrage by discharging during high electrical usage rates and charging during low electrical usage rates, daily. This behavior is considered as a “load shifting control strategy,” and is accomplished by setting the CoD parameter to the BESS operation and maintenance (O&M) costs, as shown in Eq. (1-4). However, when the CoD parameter is set to a higher value, the BESS will no longer leverage the energy-price arbitrage, but only reducing the billed peak demand of the facility. This behavior is considered as a “peak clipping control strategy,” and is accomplished by setting CoD using Eq. (1-5). This formulation considers the amount of the capital cost (CC) utilized by discharging a portion of the total energy expected to be discharged throughout the lifetime of the BESS (EL). Furthermore, Eq. (1-5) considers the expected increase in O&M costs, o, relative to the original O&M cost (O&M₀) and utilizes continuous compounding with the discount rate of the investment, r, over the expected years of BESS lifetime (L). It is important to note Eq. (1-4) does not consider r or o to ensure the CoD parameter remains low enough for load shifting to occur throughout the entire analysis but are considered in the discounted payback period calculations.

$$\begin{matrix}Co {D}_{t} = O \& {M}_{o} & ∀ t ∈ T\end{matrix} \qquad ( 1 - 4 )$$

$$\begin{matrix}Co {D}_{t} = \frac{( {e}^{r} - 1 )}{( 1 - {e}^{- r L} )} ( \frac{C C}{E L} + O \& {M}_{o} {e}^{ot} {e}^{- rt} ) & ∀ t ∈ T\end{matrix} \qquad ( 1 - 5 )$$

The objective function displayed in Eq. (1-3) was constrained with the linear constraints shown in Eq. (1-6)-Eq. (1-12). Eq. (1-6)-Eq. (1-9) constrain the BESS's state of charge (SoC) based on EC, ED, the rated energy storage capacity (CA), and the maximum depth of discharge threshold (DoD). Eq. (1-10) and Eq. (1-11) ensure that the BESS is not charged or discharged faster than the maximum power input (PI) and power output (PO) allow, respectively. Eq. (1-12) ensures that the new demand profile remains greater than 0 kW, so no net metering occurs.

$$E {C}_{t} - E {D}_{t} = S o {C}_{t} - S o {C}_{t - 1} \qquad ( 1 - 6 )$$

$$So {C}_{t = 1} = C A \times ( 1 - D o D ) \qquad ( 1 - 7 )$$

$$\begin{matrix}So {C}_{t} \geq C A \times ( 1 - D oD ) & ∀ t ∈ T\end{matrix} \qquad ( 1 - 8 )$$

$$\begin{matrix}So {C}_{t} \leq CA & ∀ t ∈ T\end{matrix} \qquad ( 1 - 9 )$$

$$\begin{matrix}E {C}_{t} \leq PI & ∀ t ∈ T\end{matrix} \qquad ( 1 - 10 )$$

$$\begin{matrix}E {D}_{t} \leq PO & ∀ t ∈ T\end{matrix} \qquad ( 1 - 11 )$$

$$\begin{matrix}N {D}_{t} \geq 0 & ∀ t ∈ T\end{matrix} \qquad ( 1 - 12 )$$

In one implementation, the linear objective function (Eq. (1-3)) and constraints (Eq. (1-6)-(1-12)) were programmed in Pyomo, a Python 3 package, in combination with the GLPK linear solver. This model was optimized with no optimality gap to ensure optimal solutions were achieved.

The following outlines research and development for various embodiments of the optimization model discussed above. Section 4 presents development of an initial optimization model that considers various BESS types and their properties, as well as modeling degradation of the BESS over time. Section 5 presents further development of the optimization model considering peak-clipping and load-shifting usage schemes, with different usage schemes affecting the cost-of-discharge in different ways. Section 6 presents development of a further embodiment of the optimization model that accounts for environmental costs associated with usage of the BESS.

### 4. Optimization for Selecting ESS Parameters

### 4-1. Introduction

Several strategies allow entities within the industrial sector to participate in industrial demand-side management of energy consumption and storage. A strategy-technology pair of particular interest is to use an energy storage system (ESS) to shift energy use such that the cost-savings of the user is maximized. Assuming that a pricing structure offered by a utility service is reflective of their goals, maximizing the savings of the user (e.g., an entity of the industrial sector, such as a manufacturing plant or another similar entity) can be equivalent to maximizing the desires of the utility service. In short, the user can use their ESS to decrease demand during on-peak hours by discharging the ESS (known as peak clipping if the peak demand is targeted), and by charging the ESS during off-peak hours (known as valley filling, or energy price arbitrage). Together, peak clipping and valley filling accomplish load shifting and result in a flatter demand profile for the industrial facility.

A computer-implemented system including an energy storage dispatch optimization model aids intermittent process facilities or continuous process facilities in optimization of ESSs such as lithium-ion battery energy storage, supercapacitor energy storage, and compressed air energy storage. Through the use of a unique Cost-of-Discharge (CoD) parameter and a dimensionless number, E, the system optimizes the size and type of a single ESS technology on a single industrial facility to maximize the return on investment, characterized by c. For the same facility, the model identifies significant differences in the optimal size of each ESS type due to their varying performance parameters.

ESSs are seen as the key to achieving global energy transformation due to the revolutionary changes they bring to energy production and consumption modes. For this reason, ESSs have been widely implemented—reaching an installed capacity of nearly 173 GW across the globe as of 2018. ESSs suitable for IDSM were identified and include lithium-ion (Li-ion) battery energy storage (BES), sodium-sulfur BES, lead-acid BES, flow BES, supercapacitor (SC) energy storage (ES), superconducting magnetic ES, flywheel ES, pumped hydro ES, and compressed air ES (CAES). The technologies modeled in the present disclosure are Li-ion BES, SC ES, and CAES since these technologies each have key advantages, but have different performance parameters. For example, Li-ion BES and SC ES have high efficiencies and energy and power densities, while CAES is less efficient and has lower energy and power densities. For example, CAES round trip efficiency has been reported between 61.6% and 70% whereas Li-ion BES round trip efficiency is reported as 90% and SC ES round trip efficiency is reported as 95%. However, Li-ion BES is very expensive and can discharge for longer periods of time (minutes-hours) than the less expensive SC ES that is more suited for short periods of high power discharge (milliseconds-1 h). CAES is a low-cost ESS with a significant discharge time (1 h-24+h), but has the aforementioned disadvantages compared to Li-ion BES and SC ES.

Peak power demand is the maximum instantaneous power a facility consumes (usually computed by taking the average energy consumed over 15- or 30-minute intervals) and users are billed based on the peak because the utility must provide enough power to satisfy all users and prevent blackout. Due to the importance of peak demand reduction, the ESS in use should have its dispatch schedules optimized to ensure the user's peak demand will be adequately reduced. However, it is imperative that this demand reduction also includes cost benefits to the industrial facility, or a facility manager is unlikely to implement ES.

### 4-2. Previous Approaches

Several studies have explored optimized ES control but overlook the economic benefits of the system. One study optimized the ES control algorithm by maximizing the utilization of the system to improve the energy sustainability of a smart home, but this study does not assess the economic benefits of the system. Furthermore, another study examined the optimal sizing of ESSs to attain a net zero energy factory, but this work overlooked the economic benefits of the ESS. Assessing the economic benefits of ESSs will increase ES penetration in the power grid and needs more examination.

Other studies analyze the economic benefits of ESSs, but are not focused on industrial facilities. For example, one study developed a linear program to minimize the demand charge of a grid connected hybrid renewable energy system (photovoltaics with batteries) by optimizing the ES dispatch schedule. Another study examined the selection of an ESS by simultaneously minimizing the levelized cost of energy and loss of power supply probability, but this was done for generic load profiles instead of industrial load profiles. A further study investigated the optimal configuration and operation strategy of photovoltaic technologies, hybrid ES with power to gas technologies and electric vehicles for a nearly zero-energy community. One additional study optimally sizes a concentrated solar power plant's thermal ES focusing on a positive net present value (NPV), but this work only sizes a single technology for a power plant. One work proposed a wind-photovoltaic-thermal ESS and minimized the levelized cost of energy while maximizing the utilization rate of transmission channels, but investigated a grid-scale distributed energy system rather than an ESS installed at an industrial facility. Similarly, another work optimized a solar-wind-pumped storage system for an isolated microgrid based on a techno-economic evaluation. Furthermore, another example determined the optimum community ESSs based on levelized costs and in-ternal rate of return as a function of the size of the community. Other studies examined the optimal dispatch of ESSs and considered the NPV of the investment, but the case studies presented were conducted for office buildings rather than industrial facilities. Due to the large electricity demands of industrial facilities, actual industrial load profiles should be analyzed in ES dispatch optimization to investigate the benefits of ES.

Conversely, other studies evaluated the profitability of using ES for industrial consumers, but their financial analyses had limitations. One study investigated the optimal sizing of different technologies at different commercial and industrial facilities in an attempt to achieve positive NPV, but the financial analysis did not consider continuous compounding or increases in operation and maintenance (O&M). Similarly, another study conducted an economic feasibility analysis using NPV and internal rate of return of the investment for five different battery technologies, but their work compounds the annual cumulated cash flow instead of continuously compounding each 15-minute interval. Also, one further study optimized the charge/discharge schedule to maximize the profit of the consumer using three kinds of batteries, but did not consider the time value of money. Another work optimized a single sized Li-ion battery ESS in a microgrid with various distributed energy sources, but does not provide a thorough techno-economic analysis because only the operation cost is considered. Furthermore, one study optimized the selection, capacity, and operation of photovoltaic and battery ESSs in commercial buildings on a half hour interval basis and found the NPV of the investment savings to estimate the payback time. Also, another work optimally determined the charging/discharging of a home energy management system as well as its ES and power capacity. While their work is necessary, only one day is evaluated, a time-of-use rate structure is not used, and there is no techno-economic analysis conducted. An accurate techno-economic analysis should be conducted on real industrial load profiles to motivate both the supplier and user of electricity to install ESSs.

In the model, production shifting and ES were considered to minimize total production cost inclusive of demand and energy charges. The present disclosure provides a description of the system 100 that applies an optimization model for optimizing the usage and demand cost savings of an ESS based on a time-of-use rate structure, and subtracting the cost to the facility for discharging the device using a ‘cost of discharge’ (CoD) parameter. This CoD parameter considers the capital investment and uses continuous compounding in every 15-minute interval, enabling the system to factor in an accurate estimation of the time value of money and the O&M cost increase as the ESS gets older. The optimization model varies three parameters: the size of an ESS to optimize the size for a facility, the type of ESS to identify the differences in the optimal for each technology, and the load profiles impact on the optimal size of each ESS.

TABLE 1-1
NOMENCLATURE
Nomenclature

| | |
|---|---|
| BES | Battery energy storage |
| CA | Energy storage capacity (kWh) |
| CAES | Compressed air energy storage |
| CC | Capital cost of ES |
| CoDₜ | Cost of discharge during time t |
| DCS | Demand cost savings |
| DPₜ | Facility power demand during time t |
| DT | Discharge time of ESS |
| EDₜ | Energy storage discharge (kWh) during time t |
| EIₜ | Energy storage inventory (kWh) at start of time t |
| EL | Lifetime energy extracted from ESS (kWh) |
| EPC | Engineering, procurement, and construction |
| EPₜ | Facility energy use during time t |
| ESS | Energy storage system |
| IDSM | Industrial demand-side management |
| L | lifetime of ESS (years) |
| Li-ion | Lithium ion |
| NOPD | The maximum peak power demand after using ES |
| NPV | Net present value |
| o | Annual increase rate of O&M |
| OPD | Maximum peak power demand of demand profile |
| OPDC | On peak demand charge |
| O&M | Operation and maintenance |
| O&M₀ | Operation and maintenance cost when ESS is new (USD/kWh) |
| PI | Maximum power to charge |
| PO | Maximum power to discharge |
| r | Annual ES investment discount rate |
| RTₜ | Cost of energy (USD/kWh) during time t |
| SC | Supercapacitor |
| T | Billing period timepoints |
| TCC | Total capital cost |
| UCS | Usage cost savings |
| USD | United States dollars ($) |

### 4-4. Computational Methodology

This disclosure presents the optimization model for maximizing the electric cost savings of the ESS using industrial demand profiles under a time-of-use rate structure. Under this rate structure, the user is billed according to two costs, energy and demand. For energy, the user is charged a rate (USD/kWh) for how much energy they use. This rate varies depending on the time of day. For the demand charge, the user is billed for the highest average demand over a 15-minute interval that occurred in the billing period, referred to as the peak power demand. Hence, savings can be obtained by either usage cost savings (UCS) and/or demand cost savings (DCS), but these savings are reduced by the previously mentioned CoD. The mathematical model is described by the following mathematical programming formulation:

$$\begin{matrix}Maximize z = \\ If charging ( {EI}_{t} - {EI}_{t - 1} > 0 ) : \\ {\sum }_{t ∈ T} \frac{( {EI}_{t} - {EI}_{t - 1} ) R {T}_{t - 1}}{η} + ( OPD - NOPD ) OPDC - {\sum }_{t ∈ T} C o {D}_{t} E {D}_{t}\end{matrix} \qquad ( 2 - 1 a )$$

$$\begin{matrix}If charging ( {EI}_{t} - {EI}_{t - 1} > 0 ) : \\ {\sum }_{t ∈ T} ( {EI}_{t} - {EI}_{t - 1} ) R {T}_{t - 1} + ( OPD - NOPD ) OPDC - {\sum }_{t ∈ T} C o {D}_{t} E {D}_{t}\end{matrix} \qquad ( 2 - 1 b )$$

$$\begin{matrix}Subject to : \\ NOPD \geq D {P}_{t} + ( {EI}_{t} - {EI}_{t - 1} ) ∀ t ∈ T\end{matrix} \qquad ( 2 - 2 )$$

$${EI}_{t - 1} = 0 \qquad ( 2 - 3 )$$

$${EI}_{t} \leq C A ∀ t ∈ T \qquad ( 2 - 4 )$$

$${EI}_{t} - {EI}_{t - 1} \leq PI ∀ t ∈ T \qquad ( 2 - 5 )$$

$${EI}_{t} - {EI}_{t - 1} \geq - PO ∀ t ∈ T \qquad ( 2 - 6 )$$

$$E {P}_{t} + ( {EI}_{t} - {EI}_{t - 1} ) \geq 0 ∀ t ∈ T \qquad ( 2 - 7 )$$

Eqs. (2-1A) and (2-1B) are the objective functions and equate to cost savings for the facility based on the usage cost savings (UCS), demand cost savings (DCS), and cost of discharge (CoD) over the billing period analyzed (T). The UCS are deduced by the first term where EI is the energy storage inventory (kWh), and RT is the cost of energy (USD/kWh). Note that when EIₜ-EIₜ₋₁ is positive (ESS is charging), this value is divided by the round trip efficiency (I) to accurately account for the additional energy pulled from the grid. The DCS are found in the second term where OPD is the maximum peak power demand of the original profile (kW), NOPD is the maximum peak power demand after using ES (kW), and OPDC is the on peak demand charge (USD/kW). The cost of discharging the ESS is found in the last term where ED is the ES discharge (kWh). Eq. (2-2) is the calculation of the on-peak demand after the use of ES and DP is the original facility power demand. Eqs. (2-3)-(2-7) are related to the inventory (amount of stored energy), charging, and discharging of the ESS. To explain, Eq. (2-3) ensures the ESS has no charge on the start of the billing period, Eq. (2-4) ensures the ESS does not charge higher than its capacity where CA is the ES capacity. Eqs. (2-5) and (2-6) ensure the ESS is not charged or discharged faster than allowed, respectively, where PI is the maximum charging power input and PO is the maximum discharging power to satisfy the technology's charge and discharge time capabilities. Eq. (2-7) ensures the ESS does not send energy back to the power grid (no net metering), as EP is the facility energy use.

The CoD parameter is derived to fully account for the cost of discharging the ESS, shown in Eq. (2-8). The CoD parameter accounts for the entire capital cost (CC) of the ESS and the energy that is expected to be discharged through its lifetime (EL). Also, the CoD parameter accounts for the O&M required to keep the ESS operating properly and the expected increase in these O&M rates—as the ESS gets older it is expected to require more O&M. This formulation uses continuous compounding to properly transform all of the cashflows associated with the ESS, including capital investment and O&M costs to an equivalent annual. Therefore, in every time interval t, there is an accurate prediction estimating the cost of discharging the ESS.

$${CoD}_{t} = \frac{( {e}^{r} - 1 )}{( 1 - {e}^{- rL} )} ( \frac{CC}{EL} + O \& {M}_{o} {e}^{ot} {e}^{- rt} ) ∀ t ∈ T \qquad ( 2 - 8 )$$

This model allows users to maximize their electrical cost savings by shifting usage from on-peak to off-peak usage times, reducing their peak power demand, while fully considering the cost of discharging the ESS. The formulation developed is linear in the decision variables, the constraints, and the objective function. Hence, the model can be in the form of a pure linear program, the class of mathematical programs that is easiest to solve in practice. Pyomo, a Python 3 package, was used to develop this model and interface with the IPOPT solver, a nonlinear optimization solver that uses a primal-dual interior point method.

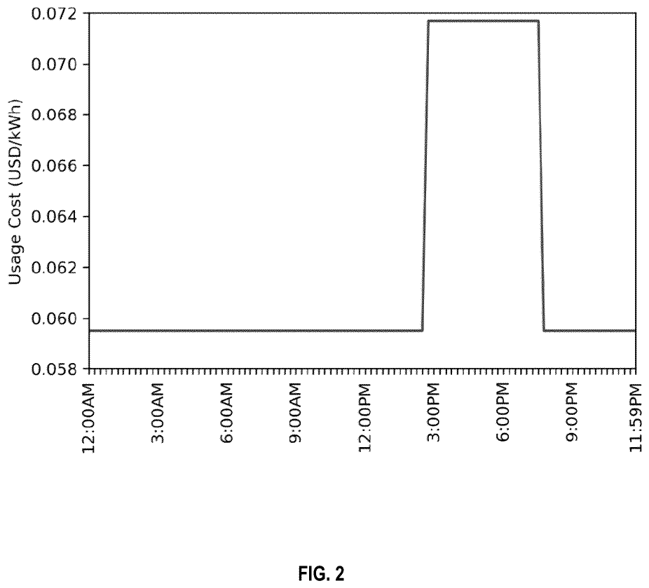

Inputs to the system include the bundled demand cost (OPDC, 20 USD/kW), and the time-of-use energy usage rate structure that varies between 0.0717 USD/kWh and 0.0595 USD/kWh during on-peak (3 p. m. to 8 p.m.) and off-peak (8 p.m. to 3 p.m.) hours, respectively (see FIG. 2). Also, the increase in O&M, o, is taken as 3% and the ES investment discount rate, r, is taken as 5%.

Using the model, results were generated to test three parameters. First, one technology (Li-ion BES) is used for one demand profile in the month of April, but many sizes are tested and an optimal sizing is found. For the next parameter variation, the same demand profile is used, but two other technologies (SC ES and CAES) have their optimal sizes found and comparisons are made. In scenario three, the optimal sizing for these technologies are found for another profile and comparisons are made for the same technology across different industrial usage cases.

The demand profiles tested are from two industrial facilities in the Phoenix, Arizona area. The month of April is analyzed to show the significance of IDSM when there is an increased cooling load during on-peak hours. Profile 1 is a manufacturer, whereas profile 2 is a wastewater treatment plant. Therefore, profile 1 has more pronounced peaks and valleys, whereas profile 2 is a more constant demand profile. These profiles were chosen to be representative of intermittent production processes and continuous production processes, respectively, to cover most industrial production processes and how ES can become a useful asset for IDSM.

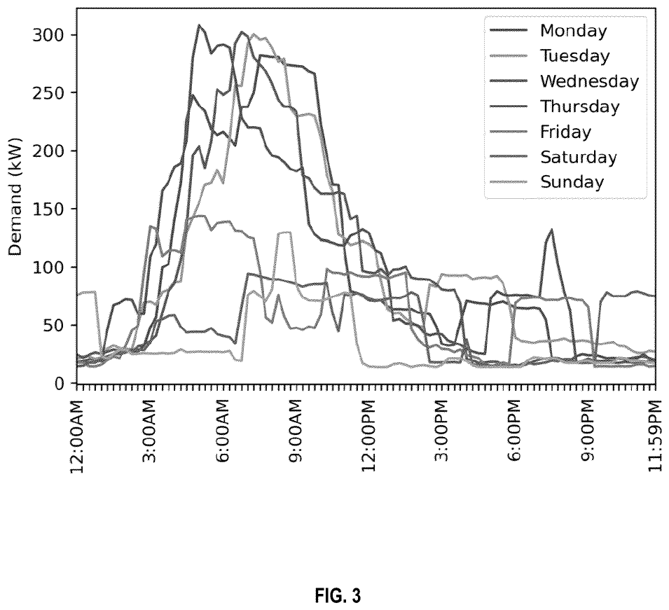

The entity's average demand profile between each day of the week is shown in FIG. 3. FIG. 3 shows a month of data condensed into the average profile for each day of the week. To explain, all Mondays in April had each 15-minute interval demand averaged together and those data points were taken as the average Monday data points and this process was carried out for the remaining days of the week.

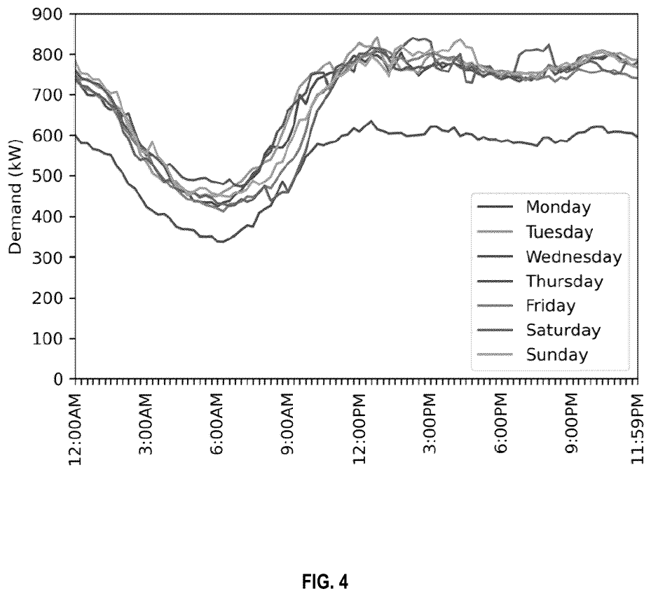

A similar analysis is conducted for the wastewater treatment plant's continuous production process, shown in FIG. 4. As seen in FIG. 4, this facility has a lower demand in the morning hours and a higher demand throughout the day and evening. However, the demand is reasonably flat when compared to profile 1. FIGS. 3 and 4 show that these facilities have highly variable demand profiles throughout the week and are good candidates for ES.

### 4-4.1 Inputs

The ESS input parameters to the proposed model are shown in Table (1-2), as obtained from literature. As previously mentioned, the energy density, power density, and efficiencies of Li-ion BES and SC ES are much higher than that of CAES. Also, the discharge times of Li-ion BES and CAES are much higher than that of SC ES, but the costs of SC ES and CAES are much lower than that of Li-ion BES. Therefore, each technology analyzed here has their key advantages and disadvantages for IDSM.

TABLE 1-2
ES INPUT PARAMETERS

| Parameter | Li-ion BES | SC ES | CAES |
|---|---|---|---|
| DT (h) | 5 | 1 | 15 |
| Lifetime (years) | 10 | 30 | 30 |
| Capital cost (CC, USD/kW) | 2312 | 304 | 958.5 |
| Capital storage cost (CSC, | 1507 | 1676 | 67.2 |
| USD/kWh) | | | |
| Energy density (Wh/L) | 381 | 18 | 5.7 |
| Power density (W/L) | 5700 | 96,667 | 0.4 |
| Round trip efficiency (%) | 91.5 | 92.2 | 61.7 |
| O&M₀ (USD/MWh) | 4.4 | 0 | 3.1 |
| Max CoD (USD/kWh) | 0.634 | 0.000242 | 0.2076 |
| Min CoD (USD/kWh) | 0.633 | 0.000242 | 0.2073 |

Many works consider engineering, procurement, and construction (EPC) costs as a function of energy storage capacity (USD/kWh) during analysis. To improve the accuracy of the analysis, a portion of the EPC costs are recognized as a fixed cost that does not vary significantly with the ES capacity. To explain, reports EPC costs of 2.4 million USD and 2.6 million USD for 4 MW/16 MWh and 10 MW/20 MWh BESs, respectively. However, this is only an 8% increase in EPC costs for a 25% increase in ES capacity due to fixed costs. Furthermore, other literature breaks down the EPC costs on commercial Li-ion BES, which vary from 536,940 USD to 952,734 USD for 300 kWh and 2400 kWh ESSs, respectively. However, 444,701 USD of these EPC costs are fixed for the inverter, structural balance of system (BOS), electrical BOS, installation labor and equipment, and EPC overhead. Therefore, 444,701 USD is taken as an approximation of the fixed costs for the installation of Li-ion and SC ESSs. Since CAES utilizes a turbine/generator, alternating current is directly generated and there is no need for the 36,000 USD inverter like Li-ion and SC ESSs which need to invert the outputted direct current to alternating current. With the addition of this fixed cost, Eq. (2-9) is modified as follows:

$${CoD}_{t} = \frac{( {e}^{r} - 1 )}{( 1 - {e}^{- rL} )} ( \frac{TCC}{EL} + O \& {M}_{o} {e}^{ot} {e}^{- rt} ) ∀ t ∈ T \qquad ( 2 - 9 )$$

where TCC is total capital cost, described in Eq. (1-10).

$$TCC = PO \times CC + CS \times CSC + FC \qquad ( 2 - 10 )$$

The sources reporting the CCs in Table (1-2) were not transparent about including these fixed EPC costs, so including them in the TCC yields a conservative estimate of the capital costs and total savings. Also, the maximum and minimum CoD values now change to 0.640 USD/kWh and 0.639 USD/kWh for Li-ion BES, respectively, 0.0003 USD/kWh and 0.0003 USD/kWh for SC ES, respectively, and 0.209 USD/kWh and 0.208 USD/kWh for CAES, respectively. The CoD for Li-ion BES is higher primarily due to its TCC. Although lithium is widely available, its high reactivity requires expensive processing to separate it from other elements resulting in high CC for Li-ion BES. It is observed that the CoD is lower than the difference between on-peak and off-peak usage rates for SC ES alone, so it is expected that this will be the only ESS to accomplish daily load shifting by shifting the usage from on-peak hours to off-peak hours by charging and discharging the ESS, respectively.

Dimensionless numbers are often used in engineering to reduce the number of variables that describe a scalable ESS and quantify the relative importance of certain variables with respect to others. A new dimensionless quantity, ϵ, is defined that represents a pronounced optimal ES capacity by dividing the total monthly cost savings (TCS) from using the ESS by the TCC as seen in Eq. (2-11).

$$ ϵ = \frac{TCS}{TCC} \qquad ( 2 - 11 )$$

ϵ is the inverse of a discounted return on investment (ROI). To explain, a larger ϵ signifies a faster return on investment due to higher TCS and/or a lower capital investment. A definitive maximum is seen when plotting ϵ vs. ES capacity, and a facility can use this to size their ESS. Considering both the TCS and TCC weighted equally in ϵ is crucial for a facility since a few dollars less TCS for a significantly smaller TCC can be a better option.

### 4-5. Results and Discussion

As previously mentioned, the optimization will be carried out for Li-ion BES, SC ES, and CAES for an intermittent process facility (profile 1) and a continuous process facility (profile 2).

### 4-5.1 Profile 1 Optimization

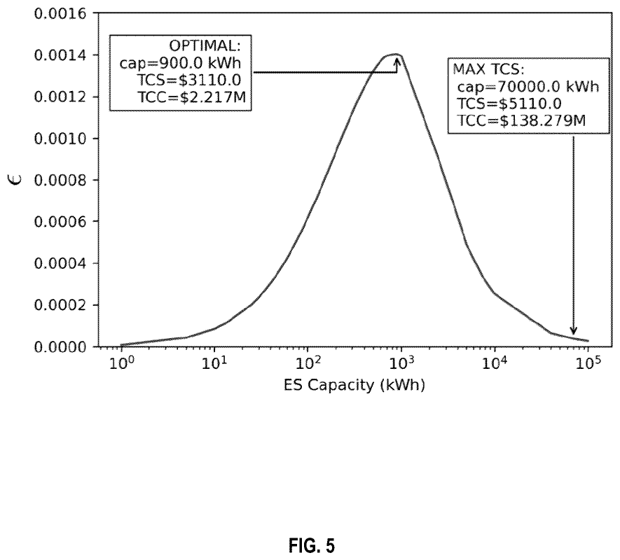

First, Li-ion BES is optimized on profile 1 and the results are shown in FIG. 5. FIG. 5 shows that to achieve the maximum TCS the ESS must be sized at a capacity (cap) of 14 MW/70 MWh for a TCS of 5110 USD and a TCC of 138,279,000 USD. However, to optimize the ROI, the Li-ion BES should be sized at 180 kW/900 kWh for a TCS of 3110 USD and a TCC of 2,217,000 USD. This is 2000 USD less monthly TCS for a 136,062,000 USD decrease in TCC.

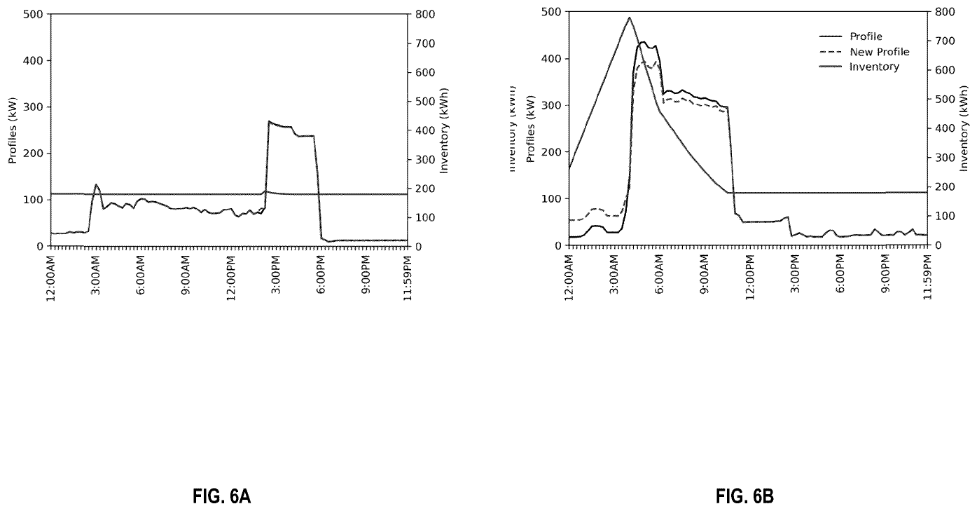

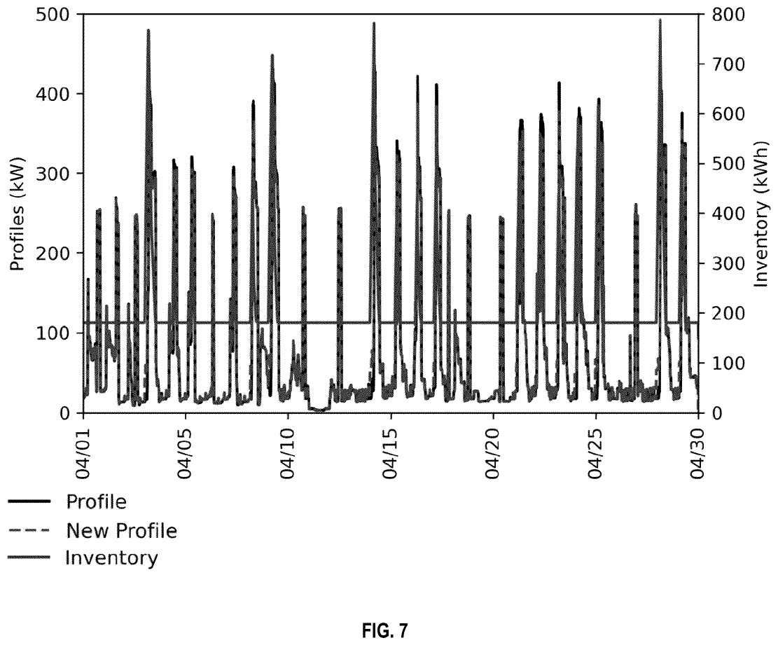

Next, the resulting facility demand profile 1 is shown in FIGS. 6A and 6B after the use of 900 kWh Li-ion BES. FIG. 6A shows the Li-ion BES does not charge or discharge in the second day of use because there was no significant peak to shave (i.e., it would not reduce the billed demand even if the peak was shaved on the second day). In FIG. 6B it is clear the peak is shaved by discharging the ESS and charging occurs during off-peak usage hours. FIG. 7 shows many peaks are shaved to achieve its maximum demand reduction of 180 kW to maximize the TCS.

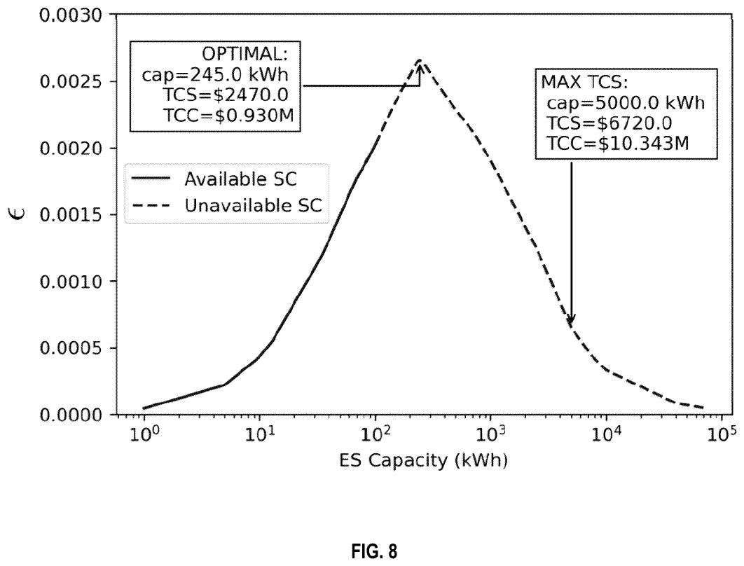

Next, SC ES sizing is optimized on profile 1 and the results are shown in FIG. 8. FIG. 8 shows that the maximum TCS for SC ES on profile 1 is 6720 USD. However, this is for a 5000 kW/5000 kWh SC ESS with a capital cost of 10,343,000 USD, whereas the fastest ROI is achieved with a 245 kW/245 kWh SC ESS yielding a TCS of 2470 USD and TCC of 930,000. Unfortunately, SC ES are not currently larger than 100 kW/100 kWh, so this is taken as the best size for the facility with a TCS of 1302 USD and TCC of 642,676 USD.

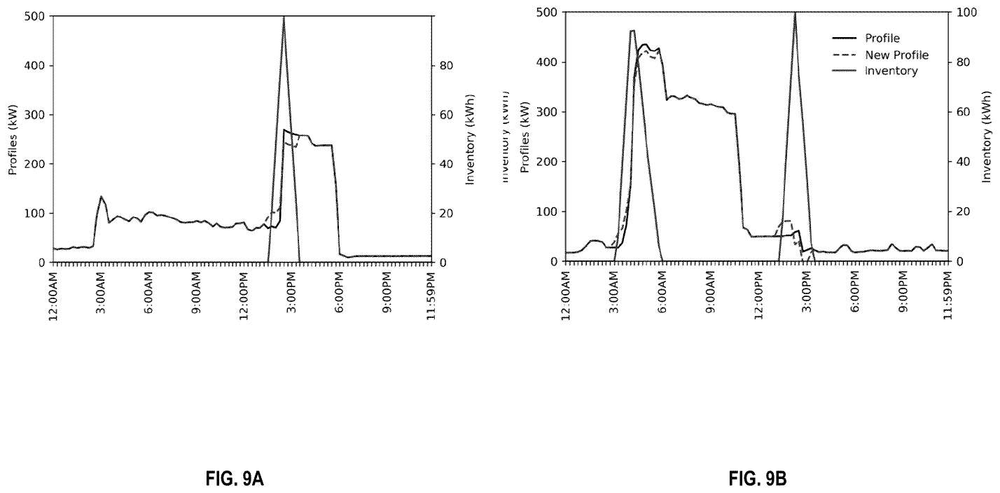

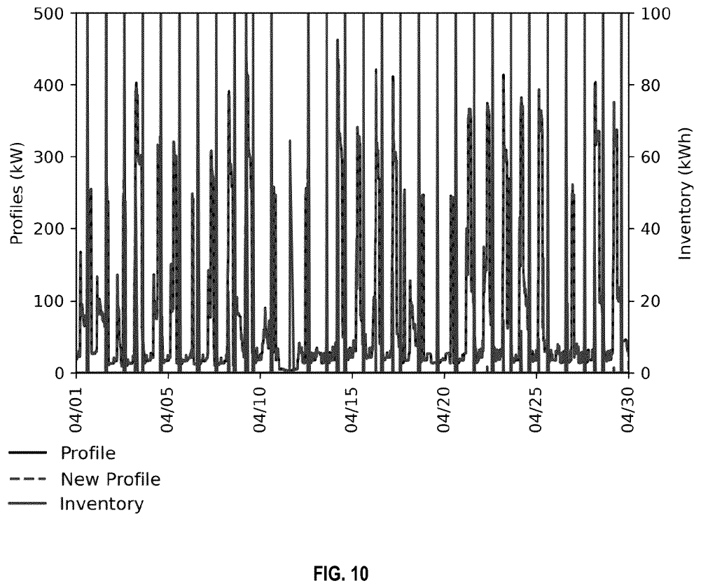

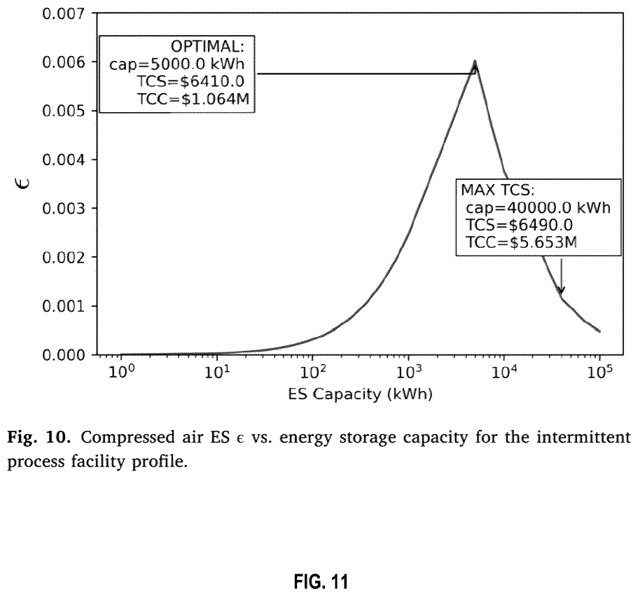

The resulting facility demand profile 1 is shown in FIGS. 9A, 9B and 10 after the use of 100 kWh SC ES. A key difference between Li-ion BES and SC ES is the lower CoD for SC ES. This is shown in FIG. 9A where SC ES is used to shift electrical usage from on-peak to off-peak hours on the second day since the CoD is less than the difference between on-peak usage rates and off-peak usage rates (charging from 2 pm to 3 pm when it is off-peak usage rates then discharging from 3 pm to 4 pm since usage rates are on-peak). However, the behavior is similar in FIGS. 6B and 9B where both ESSs shave the maximum peak. FIG. 10 shows that there are many charge/discharge cycles for the SC ESS by shifting on-peak usage to off-peak usage since the CoD is low enough for this to be optimal.

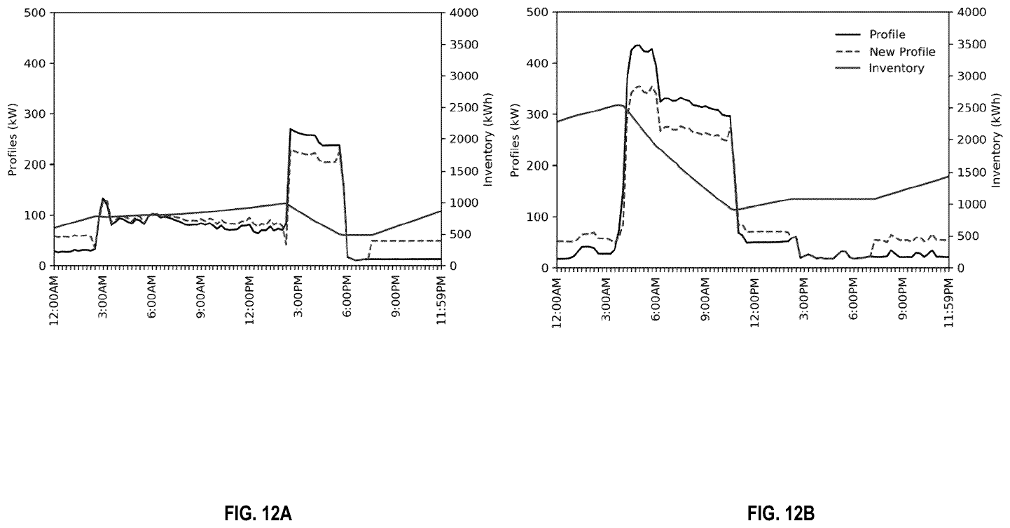

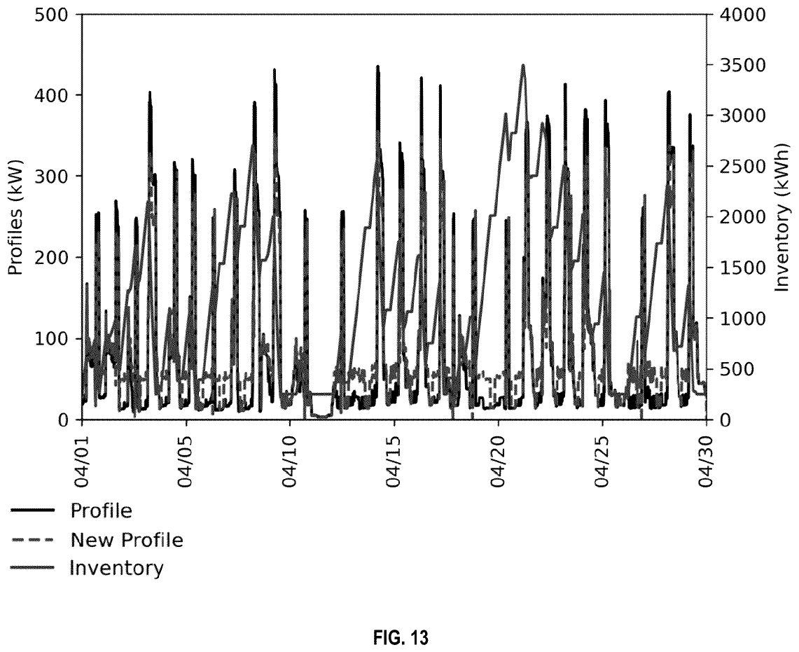

The optimal sizing of CAES on profile 1 is shown in FIG. 11. FIG. 11 shows the maximum TCS of 6490 USD is achieved with a 2666.7 kW/40 MWh CAES with a TCC of 5,653,000 USD. It is intriguing that the optimal ROI and the maximum TCS are very close to each other, as the optimal CAES is 333.3 kW/5000 kWh with TCS of 6410 USD and the CAES with the highest TCS is 2666.7 kW/40 MWh with a TCS of 6490 USD. The resulting profiles using a 333.3 kW/5000 kWh CAES are shown in FIGS. 12A, 12B and 13. FIG. 13 shows this ESS utilizes its large ES capacity and low CoD to shave many peaks and reduce the demand as much as possible.

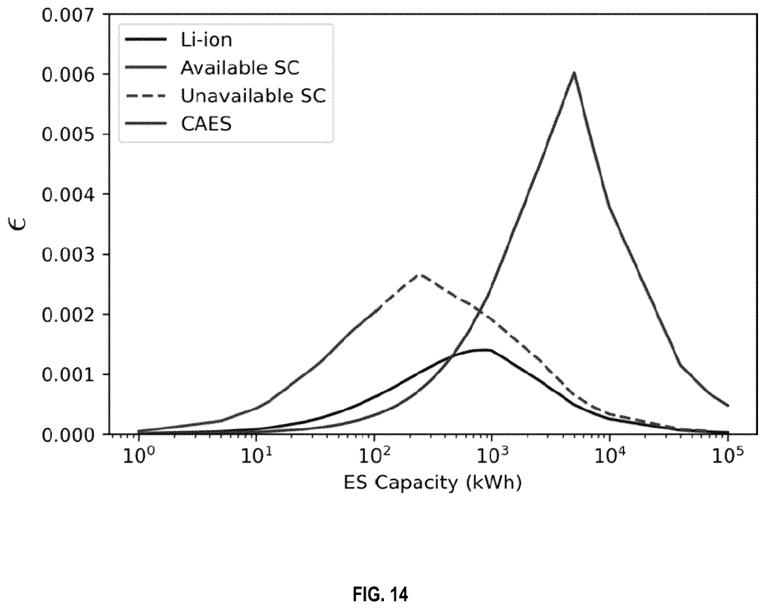

Next, the variation of E against ES capacity for profile 1 is plotted for Li-ion ES, SC ES, and CAES in FIG. 14. FIG. 14 makes it clear that CAES has the best ROI for profile 1, but it must be sized larger as well. Utilizing the energy density and power density of CAES of 5.675 Wh/L and 0.4 W/L, the 333.3 kW/5000 kWh ESS must be sized at approximately 880 m³, an amount of space possibly available for compressed air storage at an industrial facility. To explain, under a parking lot on the Texas Instruments' semiconductor chip manufacturing plant in Dallas, Texas, U.S.A. lies a 22,000 m³ water tank for the facility's chilled water thermal ES (TES). Also, the Cache Creek Casino Resort in Brooks, California, U.S.A. utilizes a 5186 m³ concrete tank for TES. By conservatively estimating industrial facilities can install CAES to a volume of 1900 m³ of storage equaling 760 kW/10.8 MWh capacity using the energy and power densities noted above. Therefore, it is assumed the CAES can be sized to achieve the optimal ROI. Similarly, the optimal sizing of Li-ion BES is attainable at 180 kW/900 kWh, but its ROI is long due to large capital costs. Conversely, the optimal sizing of SC ES at 245 kW/245 kWh is not feasible since the ESS cannot be sized larger than 100 kW/100 kWh.

### 4-5.2 Profile 2 Optimization

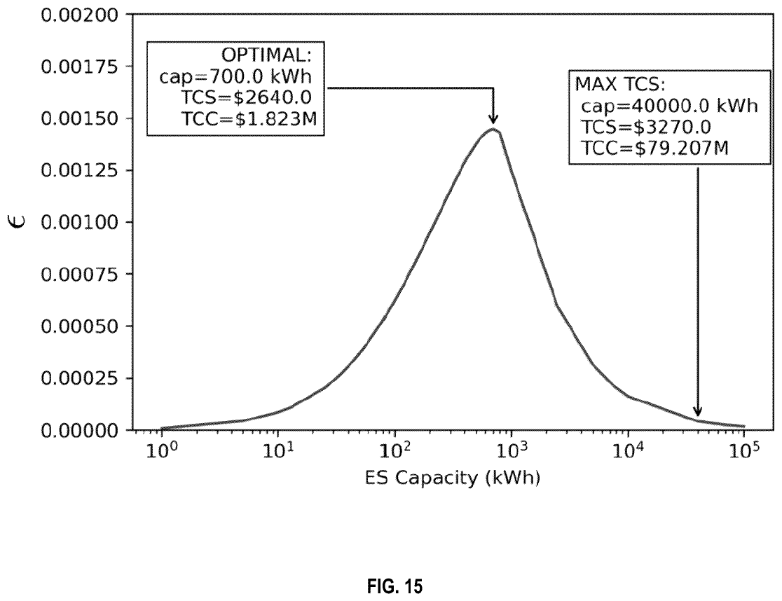

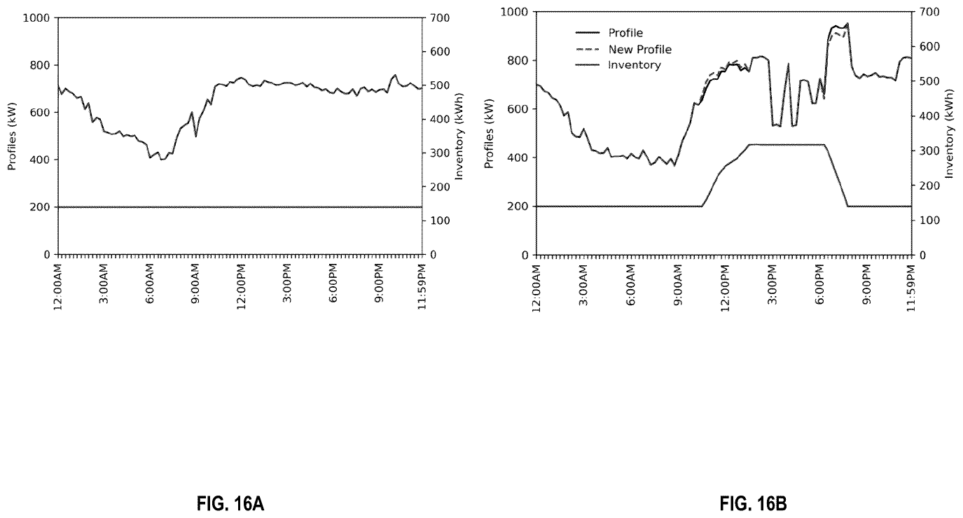

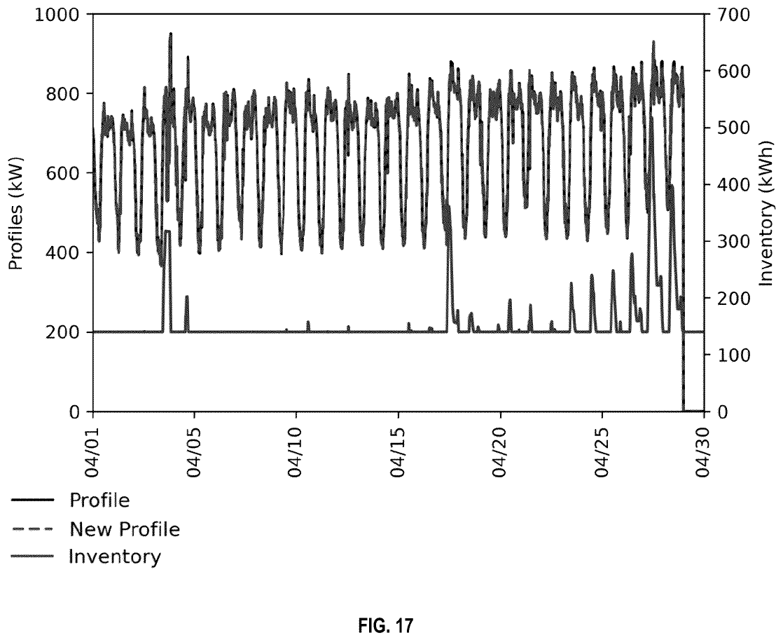

Next, the same optimization was carried out on profile two, starting with Li-ion's ROI optimized based on its ES capacity in FIG. 15. FIG. 15 shows that Li-ion BES has an optimal ROI when sized at 140 kW/700 kWh. The maximum TCS is achieved here with a 8 MW/40 MWh ESS with a TCS of 3270 USD and a CC of 79,207,000. However, the 140 kW/700 kWh ESS has a TCS of 2640 USD and a TCC of 1,823,000 USD. Profile 2's optimal Li-ion BES is sized 78% smaller than that of profile 1's, which was 180 kW/900 kWh. However, this is reasonable since profile 2's electrical demand profile is flatter and has less potential for peak demand reduction. Next, the resulting profile 2 is shown in FIGS. 16A, 16B and 17. FIG. 17 shows that the Li-ion BES does not cycle often due to its high CoD. Similar to profile 1, the ESS is used primarily for reducing the monthly peak demand.

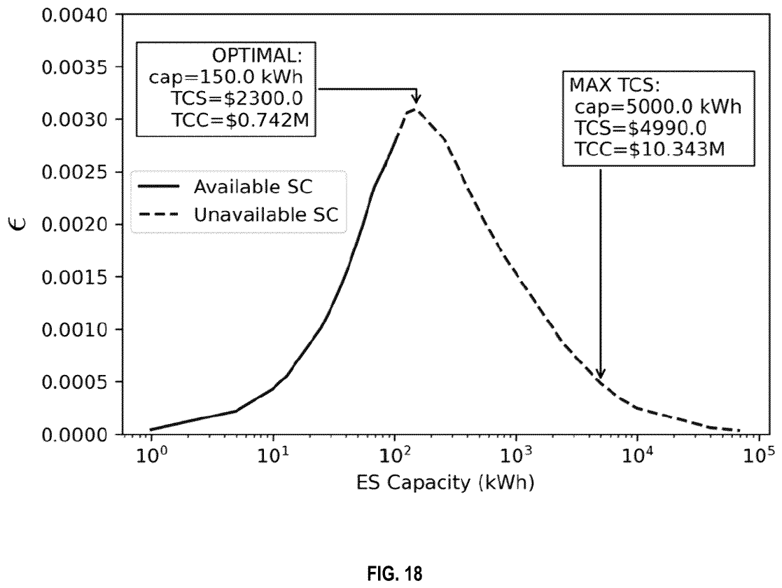

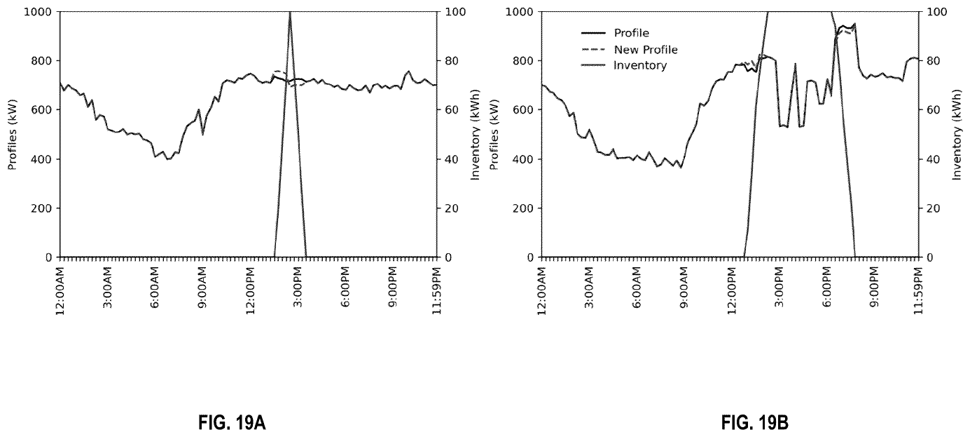

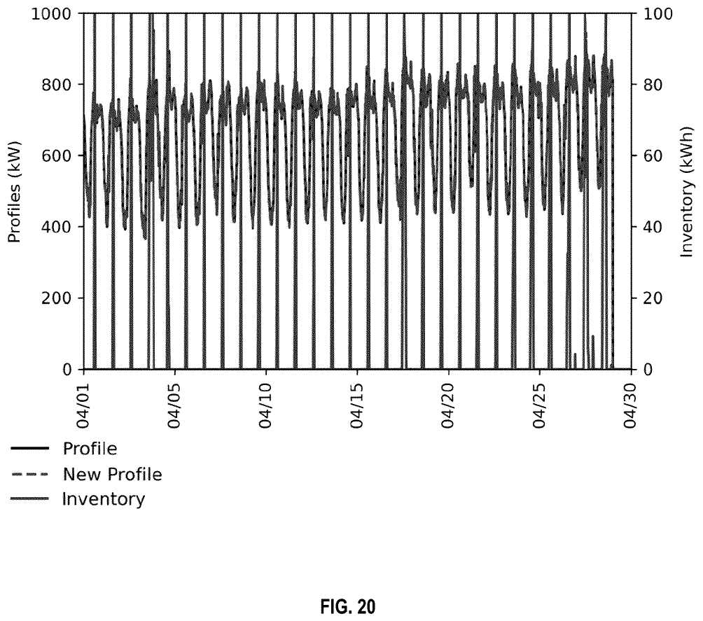

The next plot, FIG. 18, shows the optimal sizing of SC ES on profile 2. Similar to Li-ion BES, FIG. 18 shows a smaller capacity SC ESS of 150 kW/150 kWh is found to be the optimal capacity here, but a larger capacity Li-ion BES was optimal for profile 2 than profile 1. However, this is again not a feasible size for SC ES, so 100 kW/100 kWh SC ESS is taken as the optimal and the resulting profile two is shown in FIGS. 19A, 19B and 20. As expected, SC ES also exhibits daily load shifting from on-peak usage hours to off-peak usage hours as seen in FIGS. 19A and 20.

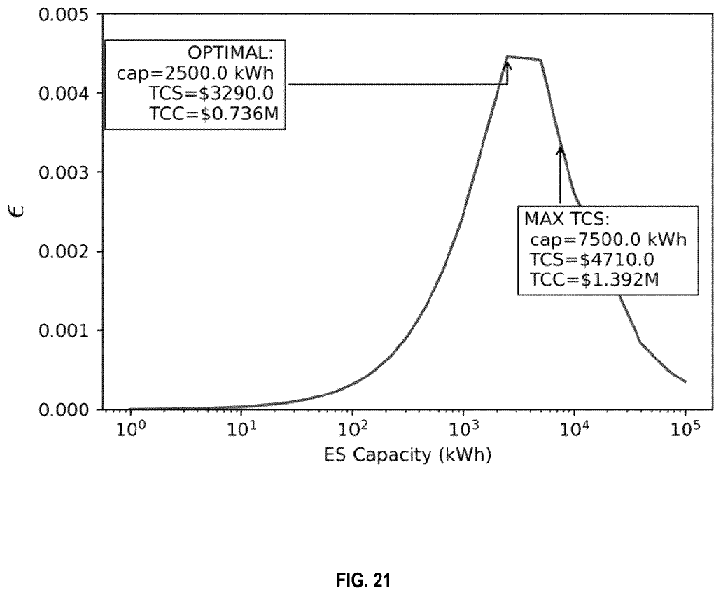

Next, the optimal sizing of CAES on profile 2 is found in FIG. 21.

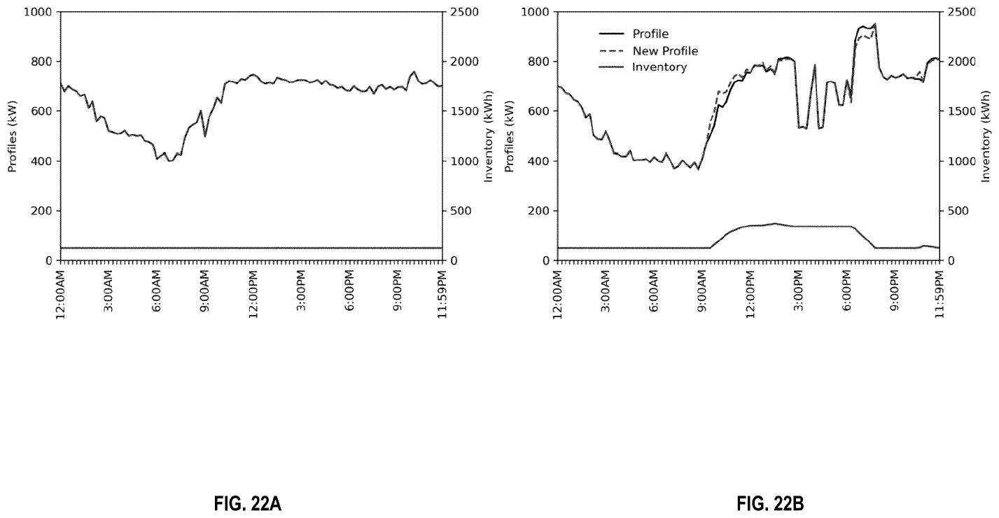

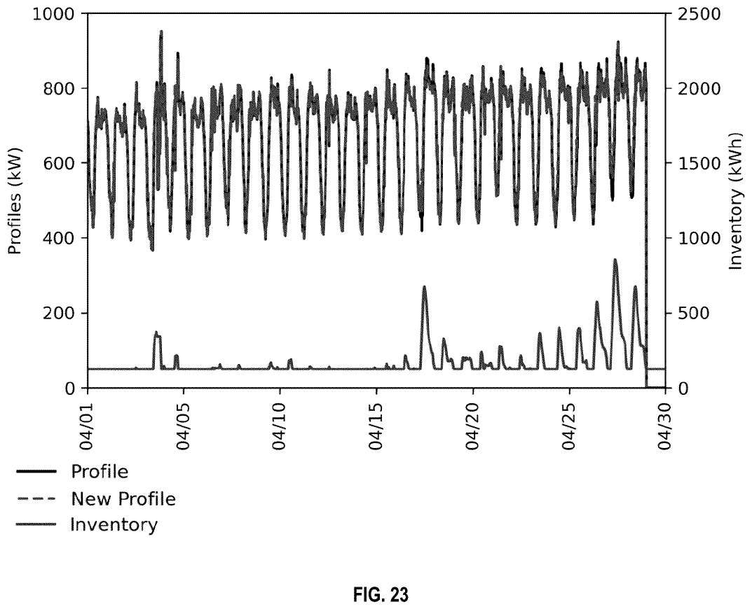

FIG. 21 shows the optimal ROI occurs for CAES sized at 166.7 kW/2500 kWh with a TCS of 3290 USD and a TCC of 736,000 USD. However, the maximum TCS is sized at 500 kW/7500 kWh with a TCS of 4710 USD and TCC of 1,392,000 USD. Like Li-ion BES and SC ES, this optimal capacity is smaller than it was for profile 1. The resulting profile 2 using this capacity CAES is shown in FIGS. 22A, 22B and 23. The results of 166.7 kW/2500 kWh CAES shown in FIG. 23 are similar to the results shown in FIG. 13 (profile 1) with many charge/discharge cycles utilized to lower the monthly peak demand as much as possible.

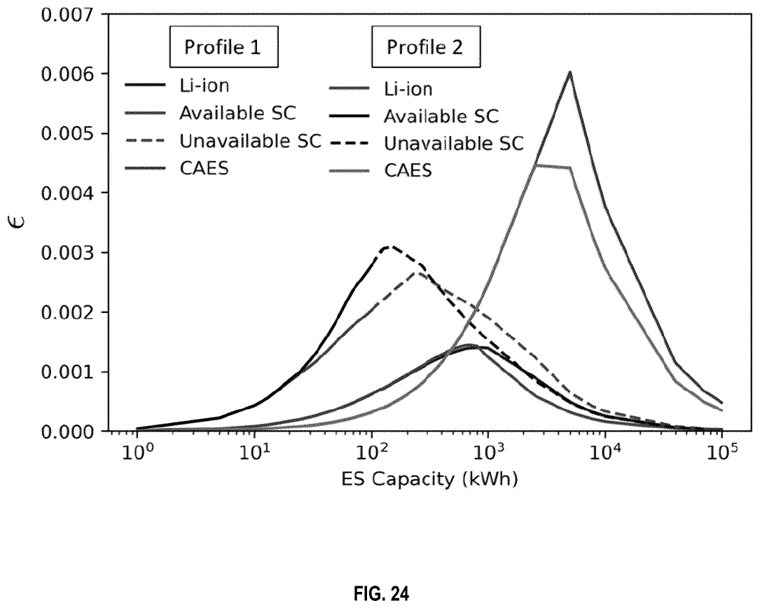

Next, the variation of E against ES capacity for profiles 1 and 2 are plotted for Li-ion ES, SC ES, and CAES on the same plot in FIG. 24. Similar to profile 1, the Li-ion BES and CAES can be sized to reach their optimal E—90 kW/450 kWh and 166.7 kW/2500 kWh, respectively. In contrast, the SC ESS must have its 150 kW/150 kWh optimal sizing reduced to 100 kW/100 kWh due to the sizing limitations of the technology.

### 4-5.3 Results Summary and Discussion

The results shown previously are tabulated in Table (1-3). Table (1-3) summarizes the month long ES dispatch optimization for two different industrial demand profiles, profile 1 and 2 being intermittent production process and continuous production process, respectively. Optimal sizing and savings from 3 different ESSs were found for both profiles and their capital costs are also presented.

TABLE 1-3
OPTIMIZATION RESULTS

| | | Profile 1 | Profile 2 |
|---|---|---|---|
| Li-ion BES | Optimal size (kW/kWh) | 180/900 | 140/700 |
| | Optimal TCS (USD) | 3110 | 2640 |
| | Capital costs (USD) | 2,217,000 | 1,823,000 |
| SC ES | Optimal size (kW/kWh) | 100/100 | 100/100 |
| | Optimal TCS (USD) | 1302 | 1783 |
| | Capital costs (USD) | 643,000 | 643,000 |
| CAES | Optimal size (kW/kWh) | 333.2/5000 | 166.7/2500 |
| | Optimal TCS (USD) | 6410 | 3290 |
| | Capital costs (USD) | 1,064,000 | 736,000 |

Li-ion BES and CAES were sized smaller for profile 2 and yielded less savings, less capital cost, and a lower ϵ so there is a faster ROI when using the optimally sized Li-ion BES and CAES on the intermittent process facility (profile 1). SC ES was sized to the highest possible capacity for both profiles but saved 481 USD more on profile 2 in the month long analysis.

The majority of TCS is due to demand cost savings, as energy cost savings yielded—0.2%, 0.3%, and—3.5% of the total for Li-ion BES, SC ES, and CAES, respectively, for the optimal sizes on profile 1. These values are negative for Li-ion BES and CAES due to lower round trip efficiencies. However, since SC ES has a higher efficiency and exhibits daily load shifting, this ESS yields positive energy cost savings.

As observed in the resulting demand profile plots, the ESSs charge during off-peak hours, and discharge during on-peak hours to facilitate demand response (DR) efforts while simultaneously maximizing the energy cost savings. Further work includes quantifying the DR benefits of the ESSs using a reliability index, like the expected energy not supplied (EENS) factor. The EENS can be determined by examining the ESS's state of charge, original demand, and demand after the use of ES.

Additional benefits of ESSs on the power grid from this dispatch algorithm, such as the dynamic thermal rating (DTR), should also be investigated in a future work. DTR determines the thermal limits of power components (transmission lines, transformers, and distribution cables) based on environmental conditions. The environmental conditions, such as ambient temperature, wind velocity, wind angle, and solar irradiation, can be utilized to determine the convective heat loss, radiated heat loss, and solar radiation heat gain of the transmission corridors, thus determining the steady state line current. The presented results should be analyzed to ensure the ESS dispatch is not limited due to the inability to redirect power flows. In turn, utilization of DTR in conjunction with the ESS dispatch will improve network capacity and reduce network congestion.

SC ES is clearly limited by its ES capacity, since the optimal for both profiles was not attainable. Recall if SC ES could have been sized to its optimal 245 kW/245 kWh capacity on profile 1, a TCS of 2470 USD would be attained. Similarly, a 150 kW/150 kWh optimally sized SC ESS used on profile 2 would yield 2300 USD TCS. Another limiting factor in SC ES is its short discharge times, making it unable to entirely shave some peaks. Even though Li-ion has many advantageous performance characteristics, it is still an expensive technology with a high CoD so its savings tend to be the lowest because it is expensive to use for IDSM. CAES has the best ROI on both profiles due to its low cost and long discharge times—making it a very capable technology for IDSM with the only hurdle being the volume required to store a large amount of air. However, other works report above ground, small-scale CAES having higher energy and power densities than large-scale CAES with the capability of sizing between 3 kW and 3 MW. Clearly, future work in using this model is identifying the key shortcomings in each ES technology to provide a pathway for future development.

Although profile two is a continuous process facility, it still achieves higher TCS than the intermittent process facility for the SC ESS.

However, this is due to the fact that the demand is flatter and has less peak demand reduction potential than the intermittent process facility so the one hour discharge time is more advantageous on the continuous process facility. Even though the demand of profile two is much higher than profile one, the Li-ion BES and CAES were sized smaller since profile 2 has less demand reduction potential.

Using an ESS to shave a facility's peak demand results in a smoother aggregate electrical demand for the power grid to satisfy. When electricity consumers run consistently, the power grid can operate primarily on baseload power generation plants. This is a strong benefit since baseload power generation plants operate at higher efficiencies than peaker plants that often ramp to satisfy unpredictable loads. Moreover, cycling of power plants leads to time consuming maintenance on the plant (lasting up to two to three weeks), decreasing grid resiliency.

The dispatch algorithms (peak clipping for Li-ion BES and CAES, daily load shifting for SC ES) developed in this work based on the CoD can be implemented by monitoring the electrical power demand of the facility. To explain, the peak clipping model would charge if the power demand were below a certain threshold and would discharge if the power demand were above a certain threshold. Furthermore, the daily load shifting model would charge the SC during off-peak usage hours and discharge the SC during on-peak usage hours. However, the model is limited since it does not account for the response time of the ESSs, which could make CAES less attractive than the fast responding Li-ion BES and SC ES.

Due to the lack of power grid network operation data, another limitation in this study is the optimal ESS sizing and location considering the network topology, operations, reliability, and economy criteria. As a result, the placement of the ESS is assumed to be integrated within the existing infrastructure without issues. However, the technical constraints of generators and transmission lines (voltage limits, generation limits, line rating limits) could be considered.

### 4-6. Conclusions

An energy storage dispatch optimization model was presented to test lithium-ion BES, supercapacitor ES, and compressed air ES on an intermittent process facility and a continuous process facility. Through the use of a unique CoD parameter and dimensionless number, ϵ, the model optimizes the size of a single technology on a single industrial facility to maximize the return on investment, characterized by ϵ.

For the same facility, the model identifies significant differences in the optimal size of each ESSs due to their varying performance parameters. To explain, Li-ion BES was sized to 180 kW/900 kWh for profile 1 to yield 3110 USD TCS over the one month interval investigated with a capital cost of 2.217 million USD. Although the monthly savings appear small compared to the capital cost, it should be remembered that the TCS account for the CoD, which considers the capital investment when deciding to discharge. Conversely, CAES was sized to 333.3 kW/5000 kWh for profile 1 to achieve 6410 USD TCS over the single month with a capital cost of 1,064,000 USD.

The model identifies differences in the optimal size for each ESS based on the facility and the optimal ESS sizing tends to be smaller for the continuous process facility (profile 2) over the intermittent process facility (profile 1). For example, Li-ion is sized to 180 kW/900 kWh on profile 1, SC ES is sized to 100 kW/100 kWh, and CAES is sized to 333.3 kW/5000 kWh. From profile 1 to profile 2, Li-ion's optimal sizing decreases from 180 kW/900 kWh to 140 kW/700 kWh, SC's optimal sizing stays the same at 100 kW/100 kWh due to technology limitations in the sizing, and CAES decreases size from 333.3 kW/5000 kWh to 166.7 kW/2500 kWh.

Limitations of ESSs have been identified through the use of the model proposed herein. For example, Li-ion BES is found to be too expensive to provide a fast ROI even though it has many other favorable characteristics (high efficiency, power density, and energy density). Similarly, SC ES would have a faster ROI if it was not limited by its ES capacity. CAES yields the fastest ROI for both facilities, due to its large ES capacity and low CoD. This model can be used to identify the shortcomings of each ESS to provide a research path for attaining widespread ES installations to help achieve global energy sustainability efforts.

### 5. General Optimization for Load-Shifting and Peak Clipping

Buildings, specifically large commercial buildings, are key contributors to the increasing electrical energy demand that is taxing the reliability of an aging U.S. power grid. Through utility sponsored demand response programs and electrical energy storage systems, large buildings can simultaneously save money on their electricity bill and improve power grid reliability with little to no change in their operations. Few studies have explored demand response benefits and appropriate control strategies for large commercial buildings. In this second embodiment, optimal peak clipping and load shifting control strategies of a Li-ion battery energy storage system are formulated and analyzed over 2 years of 15-minute interval demand data for a large commercial building in the Southwest United States. Furthermore, this analysis assesses the discounted payback period of a Li-ion battery energy storage system while considering cases with and without enrollment in the local utility's event-based demand response program. Degradation in the Li-ion battery energy storage system's rated power and capacity are considered throughout this analysis. Key findings in this section show that enrollment in event-based demand response can provide a reasonable (<10 years) discounted payback period of Li-ion battery energy storage systems.

### 5-1. Introduction and Motivation

Several types of DR programs exist for electricity consumers to participate in. The Federal Energy Regulatory Commission defines DR as “the ability of customers to respond to either a reliability trigger or a price trigger from their utility system operator, load-serving entity, regional transmission organization/independent system operator, or other demand response provider by lowering their power consumption”. There exists both price-based DR programs and incentive- or event-based DR programs. Price-based DR programs allow consumers to modify their electricity consumption to take advantage of on-peak and off-peak electricity usage rates that are pre-defined for each day, week or season. Energy storage systems are an effective solution for price-based DR programs since they can effectively shift demand to leverage the energy-price arbitrage by charging during off-peak hours and discharging during on-peak hours. Incentive or event-based DR programs allow utility companies to decide when specific consumers curb their electricity demand in exchange for financial compensation. Unlike price-based DR, incentive- or event-based DR programs are typically infrequent and occur on a schedule that is known only a short time prior to the event. Energy storage systems are also an effective solution for event-based DR programs because the system can simply discharge throughout a DR event to curb the net electricity demand of the consumer.

TABLE 2-1
Nomenclature

| | |
|---|---|
| BESS | Battery energy storage system |
| DR | Demand response |
| DT | Discharge time |
| LS | Load shifting |
| O&M | Operation and maintenance |
| PC | Peak clipping |

Parameters

| | |
|---|---|
| CA | Rated energy storage capacity (kWh) |
| CoD | Cost of discharge (USD/kWh) |
| DC | Demand cost (USD/kW) |
| DCS | Demand cost savings (USD) |
| DP | Power demand of facility (kW) |
| DS | Desired demand shaving (kW) |
| EI | Energy storage inventory (kW) |
| ED | Energy discharged (kWh) |
| i | Inflation rate (%) |
| i_{.e.} | Annual utility cost increase rate (%) |
| L | Energy storage system's calendar lifetime (yr) |
| ND | New billed peak demand (kW) |
| o | Annual operation and maintenance increate rate (%) |
| OD | Original billed peak demand (kW) |
| PI | Maximum power input (kW) |
| PO | Maximum power output (kW) |
| RT | Cost of electrical energy (USD/kWh) |
| T | Time intervals in analysis period |
| T_{DR} | Time Intervals in demand response event |
| TCS | Total cost savings (USD) |
| TCSₘₒ | Total cost savings in month (USD) |
| UCS | Usage cost savings (USD) |

Greek letters

| | |
|---|---|
| ∈ | Dimensionless parameter characterizing return on investment |
| η | Round-trip efficiency (%) |

Although energy storage systems can allow electricity consumers to effectively participate in DR programs, the capital costs of such systems can be prohibitive. Some report an energy storage system capital recovery of 8-9 years with peak load shaving and demand management as the profit modes. However, DR should be considered in the energy storage planning because of the improved economics.

Large electricity consumers can operate battery energy storage systems (BESSs) in many ways. Typical control strategies for energy storage systems target a facility's peak demand (peak clipping (PC) control strategy) and/or daily load shifting (load shifting (LS) control strategy). In a PC control strategy, the energy storage systems' dispatch is focused on peak demand reduction and therefore charges and discharges less. Conversely, a LS control strategy not only reduces the billed peak demand but leverages the energy-price arbitrage daily. BESSs that are subjected to daily LS control experience more cyclic degradation, typically resulting in shorter useful lifetimes than BESSs subjected to PC control.

Several studies have optimized the techno-economics of PC control strategies, but event-based DR incentives are often overlooked. For example, Oudalov et al. determined the optimally sized BESS for a PC application at an industrial facility. Zheng et al. analyzed the benefits of a hybrid battery-super capacitor (SC) energy storage system in a data center with four control algorithms: the first being peak shaving, and the others related to the operation of the servers in the data center. Also, Nottrott et al. developed an optimization model to achieve a set amount of peak load shaving using a photovoltaic and Li-ion hybrid system. Zhao et al. developed a multi-source optimal scheduling model of wind-nuclear-thermal-storage-gas for PC. Elio et al. developed an optimization model with the objective of maximizing a facility's cost savings and showed PC control for Li-ion BES and compressed air energy storage at two industrial electricity consumers. However, these studies did not include DR incentives.

Other studies show both PC and LS demand side management strategies, but do not evaluate the economics of each control strategy or the event-based DR benefits. Ma et al. developed predictive control strategies to solve the problem of energy storage “dead time” without increasing the energy storage capacity. Although their results show both PC and LS characteristics, their objective was not to maximize the cost savings or compare between these strategies. Ebrahimi and Ziaba-sharhagh developed PC and LS control algorithms for energy storage systems on generic load profiles, but did not assess the economics of the systems. Hemmati and Saboori optimized a BESS to charge during off-peak hours and discharge during on-peak hours, but their analysis did not consider the economics of the system. Chapaloglou et al. developed a control algorithm of power flows in a BESS that achieved PC and LS, but did not discuss the economics of the system. More research is needed to assess which of the two control strategies is more appropriate based on economics considerations.

Some studies optimize energy storage dispatch and conduct time-dependent economic analyses, but do not assess event-based DR program benefits. For example, He et al. simultaneously minimized the levelized cost of energy and loss of power supply probability but did not quantify the impact of event-based DR incentives. Mazzoni et al. optimized the dispatch strategy of energy storage systems and their techno-economic benefits but overlooked the cost benefits of event-based DR programs. Hartmann et al. investigated the optimal sizing of different energy storage systems at commercial and industrial facilities to achieve positive net present value, but did not assess the cost incentives of event-based DR with the use of the energy storage systems. Furthermore, Telaretti et al. focused on the economic viability of five different BESSs but did not assess event-based DR program benefits. Faisal et al. optimized the energy storage dispatch of a Li-ion BESS to minimize costs, but also overlooked the event-base DR incentives. Mariaud et al. optimized the selection and capacity of BESSs and assessed the net present value of the investment, but did not assess the effect of event-based DR program benefits. Sardi et al. considers most cost benefits in their net present value and discounted payback period analysis of a community energy system, but did not consider event-based DR incentives. Similarly, Feng et al. maximizes the revenue from a BESS under optimal operation and considers the cost benefits of ancillary services, but omits event-based DR incentives. Yuan et al. considered the profitability of a BESS integrated into a 100% renewable energy system. Although they considered the techno-economics of the price arbitrage, they did not consider event-based DR incentives. Khaloie et al. developed a risk-averse optimal BESS bidding strategy without consideration of event-based DR.

Other studies assess various DR benefits, but do not evaluate large commercial facilities. Metwaly and Teh implemented DR (through PC and valley filling) and observed a flatter demand profile due to LS. Although their work contributed to reinforcing the reliability of electricity transmission networks, they did not provide an economic analysis of the BESS. Li et al. contributed an optimal dispatch strategy and a DR incentive mechanism in an islanded microgrid application. Peng et al. included event-based DR incentives in their single month analysis of 3 industrial electricity consumers, but their analysis projects a payback period from this single month with DR events and does not consider the time value of money. To explain further, they analyzed a summer month where there were 2 DR events and assumed there would be these 2 events in every month of the year. While this may be the case in the Chinese power grid, typical Southwestern United States utilities only call for DR events on the highest temperature days of the year. Shen et al. studied the economic and carbon emission effects of DR, but their work considered a microgrid rather than a large electricity consumer. Hamidan & Borousan simultaneously optimized distributed generators and BESSs to improve the reliability of distribution networks, rather than large electricity consumers. Kang et al. implemented an energy storage control algorithm to increase the reliability of energy networks and does not assess the direct profits to the user. Merten et al. optimized the profitability of a BESS in virtual power plants (considering wind, photovoltaics, and thermal generation), but did not evaluate large electricity consumers.

As discussed, many studies have developed PC and LS control strategies for energy storage systems, but limited research has been conducted on large electricity consumers enrolled in event-based DR. Therefore, this disclosure evaluates the merits of PC and LS energy storage dispatch optimal control strategies for a large commercial building with and without enrollment in an event-based DR program. Furthermore, time sensitive discounted payback period analyses are evaluated on the optimally sized BESSs. Accurate analyses of the optimal discounted payback period of BESS investments are essential because BESSs can enable large electricity consumers to participate in event-based DR. No significant changes are made to the consumer's electricity use except simply discharging during DR events to increase the reliability of the existing electrical power grid.

### 5-2. Methodology

The PC and LS optimal control strategies of an energy storage system are considered in this disclosure along with economic analysis of event-based DR savings and discounted payback period. Two years of 15-minute interval electricity demand was collected from a large commercial facility in the southwestern United States following a rate plan.

### 5-2.1 Assumptions

There are several important assumptions made to simplify the analysis conducted in this work. For example, it is assumed that net metering (sending electricity back into the electrical grid) is allowed during DR events and the electricity consumer will be compensated at the market cost. Furthermore, the discounted payback period of a Li-ion BESS with and without enrollment in the DR program is calculated with the following assumptions: (1) utility costs (including DR incentives) increase (i.e.) at 3.9% annually, (2) operation and maintenance costs increase (o) at 3% annually, (3) the inflation rate (i) is 1.76% annually, (4) BESS is paid in full (no interest on a loan), (5) operation and maintenance costs pay for replacement of the BESS when the energy storage capacity drops below 80% of its original energy storage capacity, (6) the capital cost is calculated utilizing the low end of the Li-ion installed cost ranges with consideration of the fixed cost.

### 5-2.2 Peak Clipping and Load Shifting Control Strategies Computational Methodology

A method associated with PC and LS control strategies includes receiving, at a processor in communication with a memory, one or more operating statistic values descriptive of energy consumption of an entity. The method further includes iteratively evaluating, at the processor, a cost reduction value of an energy storage device over a plurality of storage device parameter values and with respect to the one or more operating statistic values, the cost reduction value incorporating a baseline usage cost, a demand cost, and a cost-of-discharge of the energy storage device that are dependent upon one or more storage device parameter values of the plurality of storage device parameter values.

Evaluating the cost reduction value of the energy storage device for a storage device parameter value of the plurality of storage device parameter values includes: a) determining, for a time increment of a plurality of time increments of the first time period, an incremental usage cost for the energy storage device; b) determining the baseline usage cost by summation of incremental usage costs for each time increment of the plurality of time increments of the first time period; c) determining the demand cost by taking a product of an on-peak demand charge value and a maximum peak power difference between a first maximum peak power demand value without the energy storage device and a second maximum peak power demand value with the energy storage device; d) determining, for a time increment of the plurality of time increments of the first time period, an incremental discharge cost for the energy storage device.

Evaluating the cost reduction value of the energy storage device for a storage device parameter value of the plurality of storage device parameter values further includes: e1) (for LS) determining a cost-of-discharge of the energy storage device for load-shifting that incorporates a cost of operation and maintenance, where the energy storage device applies load-shifting to charge during off-peak hours and discharge during on-peak hours; and e2) (for PC) determining the cost-of-discharge of the energy storage device for peak-clipping by summation of incremental usage costs for each time increment of a plurality of time increments that incorporates a cost of operation and maintenance using continuous compounding, where the energy storage device applies peak-clipping when the cost-of-discharge exceeds a difference between on-peak and off-peak usage rates. Evaluating the cost reduction value of the energy storage device for a storage device parameter value of the plurality of storage device parameter values further includes: f) determining the cost reduction value, based on the cost-of-discharge of the energy storage device, the demand cost and the baseline usage cost for the storage device parameter value.

The method can further include selecting, at the processor and based on the cost reduction value of the energy storage device as evaluated, a storage device parameter value of the plurality of storage device parameter values that result in the cost reduction value being at a maximal value.

The incremental usage cost incorporates: a baseline energy cost per unit of energy delivered to the energy storage device; and a difference between a current energy storage inventory of the energy storage device and a previous energy storage inventory of the energy storage device. The incremental usage cost can further incorporate a round trip efficiency value when the energy storage device when in a first charging state.

The one or more operating statistic values descriptive of energy consumption can include: the on-peak demand charge value; data indicative of a time-of-use energy usage rate structure; and data indicative of a quantity of energy consumed by the entity including time-of-use.

The plurality of storage device parameter values include: one or more parameters indicative of a capacity of the energy storage device; one or more parameters indicative of a type of the energy storage device; and one or more parameters indicative of a load profile impact on the energy storage device.

Key differences from Embodiment 1 discussed in the previous section include alterations to the cost of discharge (CoD) parameter to achieve PC and LS strategies. The optimal control strategy is formulated and solved utilizing Pyomo, a Python 3 package, along with the GLPK linear solver. To ensure the optimum solution is found, no optimality gap is utilized within the GLPK solver. The formulation is outlined in Algorithm 1 below:

Algorithm 1: BESS Control

Maximize z =
If charging(Elₜ − Elₜ₋₁ greater than 0):
${\sum }_{t ϵ T} \frac{( {EI}_{t} - {EI}_{t - 1} ) {RT}_{t - 1}}{η} + ( OD - ND ) DC - {\sum }_{t ∈ T} {CoD}_{t} {ED}_{t} \qquad ( 3 - 1 )$
If discharging (Elₜ − Elₜ₋₁ < 0):
${\sum }_{t ϵ T} ( {EI}_{t} - {EI}_{t - 1} ) {RT}_{t - 1} + ( OD - ND ) DC - {\sum }_{t ∈ T} {CoD}_{t} {ED}_{t} \qquad ( 3 - 2 )$
Subject to:
$ND \geq {DP}_{1} + ( {EI}_{t} - {EI}_{t - 1} ) ∀ t ∈ T \qquad ( 3 - 3 )$
${EI}_{t = 1} = CA \times ( 1 - DoD ) \qquad ( 3 - 4 )$
${EI}_{t} \geq CA \times ( 1 - DoD ) ∀ t ϵ T \qquad ( 3 - 5 )$
${EI}_{t} \leq CA ∀ t ∈ T \qquad ( 3 - 6 )$
${EI}_{t} - {EI}_{t - 1} \leq PI ∀ t ∈ T \qquad ( 3 - 7 )$
${EI}_{t} - {EI}_{t - 1} \geq - PO ∀ t ∈ T \qquad ( 3 - 8 )$

where Eqs. (3-1) and (3-2) are the objective functions, that account for the energy usage cost savings (UCS), power demand cost savings (DCS), and the cost of using the system over each billing period (T). Eqs. (3-1) and (3-2) differ in their UCS, where Eq. (3-1) accounts for the additional energy pulled from the grid to account for the round-trip efficiency of the energy storage system (r). The UCS is calculated by the change in energy storage inventory (EI, kWh) multiplied by the cost of energy (RT, USD/kWh). The DCS are calculated by the second term in the objective function by subtracting the new billed peak demand (ND) from the original billed peak demand (OD) and multiplying by the demand cost (DC, USD/kW) for the billing period. The last term in the objective function accounts for the cost of discharging the system (CoD, USD/kWh), which varies for the PC and LS control strategies, multiplied by the amount of energy discharged from the energy storage system (ED). Constraint (3-3) calculates the ND by analyzing the power demand of the facility (DP) and the amount of energy discharged from the energy storage system. Constraint (3-4) ensures EI begins the billing period with enough energy to satisfy the depth of discharge (DoD) constraint, whereas constraint (3-5) ensures the EI is above the DoD threshold throughout the analysis. Constraint (3-6) ensures the EI does not exceed the rated energy storage capacity of the energy storage system (CA). Constraints (3-7) and (3-8) ensure the energy storage system does not charge or discharge, faster than the maximum power input (PI) or power output (PO), respectively, based on the technological constraints of the energy storage system.

As previously mentioned, varying the value of the CoD changes the operating strategy from PC to LS. PC is a demand-side management strategy that targets minimizing the billed peak demand. However, to discharge during the peak demand, the energy storage system is charged during off-peak hours (valley filling, or energy price arbitrage) to take advantage of lower utility rates. The LS control strategy, however, charges during off-peak hours and discharges during on-peak hours daily consistently shifting the power demand to maximize UCS and achieve some DCS. When the CoD is greater than the difference between on peak and off peak usage rates, the optimal control strategy will target reducing the peak demand and the PC control strategy is utilized. Conversely, when the CoD is less than the difference between on peak and off peak usage rates, the energy storage system will exhibit daily LS to maximize savings. In the LS control strategy, daily LS is accomplished by only considering the operation and maintenance cost of using the system (see Eq. (3-9)). Alternatively, in the PC control strategy, the portion of the energy storage system's capital cost used from discharging is considered along with the operation and maintenance cost from the amount of discharge (see Eq. (3-10)). The formulation in Eq. (3-10) considers the portion of the capital cost by dividing it by the expected energy to be discharged throughout its lifetime (EL) and considers the operation and maintenance cost to be continuously compounding at a rate of ‘o’ (3%) because as the system gets older it is expected to require more operation and maintenance. Furthermore, this formulation utilizes continuous compounding in all 15-minute intervals to properly account for all cashflows in the system to an equivalent annual value.

$${CoD}_{t} = O \& {M}_{o} ∀ t ∈ T \qquad ( 3 - 9 )$$

$${CoD}_{t} = \frac{( {e}^{r} - 1 )}{( 1 - {e}^{rL} )} ( \frac{CC}{EL} + O \& {M}_{o} {e}^{ot} {e}^{- rt} ) ∀ t ∈ T \qquad ( 3 - 10 )$$

To account for degradation in the energy storage capacity, the number of Li-ion lifecycles (4,075) indicates the number of charge/discharge cycles the system can sustain before its energy storage capacity degrades from 100% to 80% with a linear relationship (cyclic degradation). Similarly, the calendar lifetime of Li-ion BES (L, 10 years) is the duration of time before the energy storage capacity degrades from 100% to 80% with a linear relationship (calendar degradation). As such, after each month of optimization, the degradation of the energy storage capacity is considered as the maximum of cyclic and calendar degradation. Then, the new energy storage capacity is passed into the computational framework for optimization on the next month.

The inputs to the optimization framework include two years of 15-minute interval demand data (January 2020 through December 2021) and the associated time-of-use (TOU) utility pricing. The energy storage dispatch is optimized using Eq. (2-1) through Eq. (2-8) and Eq. (2-9) for the LS control strategy and Eq. (2-1) through Eq. (2-8) and Eq. (2-10) for the PC optimal control strategy. To determine an optimal energy storage capacity, sizes ranging between 1 and 10,000 kWh each with discharge times (discharge times) of 1 h, 2 h, 3 h, 4 h, and 8 h are utilized since they correlate to the duration of possible DR events. The energy storage capacity divided by the discharge time is considered the rated power of the BESS. Utilizing a dimensionless parameter (E) that characterizes the return on investment (Eq. (11)), an optimal energy storage capacity (kWh), discharge time (from 1 h, 2 h, 3 h, 4 h, and 8 h), and control strategy (PC or LS) is determined.

$$∈ = \frac{Total cost saving over 2 year analysis}{CC} \qquad ( 3 - 11 )$$

### 2-2.3 Event-Based Demand Response Program Methodology

Since enrollment in DR programs should be considered in energy storage planning, the PC and LS optimal control strategies were modified with an additional constraint to ensure the energy storage system is discharging during DR events (Eq. (3-12)).

$$( {EI}_{t} - {EI}_{t - 1} ) \leq DS ∀ t ∈ {T}_{DR} \qquad ( 3 - 12 )$$

Where T_{DR} includes the time intervals of the DR event and DS is the desired demand shaving (set as the rated power output of the BESS). The DR events' time intervals considered in this analysis are in the evenings (2 h durations) on the 8 highest temperature days in 2020 and are in the evenings (2-3 h durations) on the 7 highest temperature days in 2021. The incentives considered are 40 USD/kW reduction and 0.09 USD/kWh.

### 5-2.4 Discounted Payback Period Analysis Methodology

The calculation of the discounted payback period tracks the total cost savings (TCS) from using the BESS and proceeds as follows: (1) initialize TCS to the negative of the capital cost, (2) optimize one month of data and add the net present value of the monthly TCS (TCSₘₒ) to the running total of the TCS utilizing Eq. (3-13), (3) calculate the degradation that occurred from operating the battery in that month, (4) if the energy storage capacity is <80% of the starting energy storage capacity, reinitialize the energy storage capacity to the starting capacity, (5) go back to (2) until TCS is greater than 0, indicating the energy storage system has paid back.

$$TCS = {\sum }_{mo} \frac{{{TCS}_{mo} ( 1 + {i}_{e} )}^{\frac{mo}{12}} - O \& {M ( 1 + o )}^{\frac{mo}{12}}}{{( 1 + i )}^{\frac{mo}{12}}} \qquad ( 3 - 13 )$$

It is important to note that the DR economic incentives are included in TCSₘₒ during months that experience DR events for the analyses with DR enrollment, so these incentives are assumed to increase at the same rate as utility costs.

### 5-3. Results and Discussion

The optimization was carried out according to the methodology section and the results are presented and discussed in this section. First, the optimally sized systems with and without DR enrollment are determined. Then, with the same sized system, the PC and LS control strategies are compared with and without DR enrollment. Following this, the discounted payback periods are determined for the optimally sized BESSs for the PC and LS optimal control strategies with and without DR enrollment.

5-3.1 Optimal Peak Clipping and Load Shifting Control Strategies Results without DR Enrollment

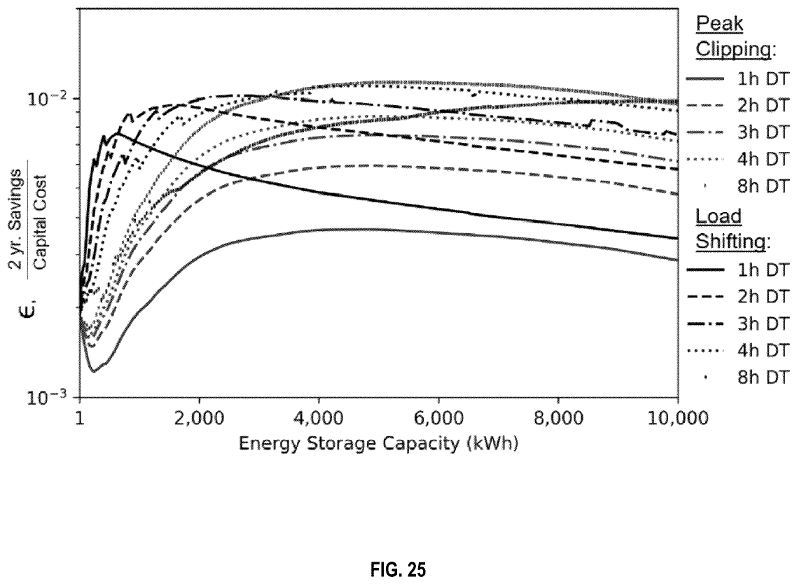

FIG. 25 characterizes the variation in E for different energy storage capacities, to determine the optimal capacities for the PC and LS control strategies and each discharge time without enrollment in the event-based DR program. The maximum E values and the coincident energy storage capacities are tabulated in Table (2-2). It is observed that the optimal energy storage capacity is larger for the PC control strategy but E was smaller than the LS control strategy for all discharge times except for 8 h. Additionally, with an 8 h discharge time and PC control strategy, the highest E value is observed without event-based DR enrollment. Furthermore, it is observed that the optimal energy storage capacity increases with the discharge time for both control strategies, which is expected because longer discharge times correspond to a lower power output for the same energy storage capacity. The PC control strategy has an increasing ϵ with increasing discharge times (and energy storage capacities), while the LS control strategy has a maximum ϵ at a 4 h discharge time. Trends in the data are generally smooth, but in some regions (e.g., 8,000-10,000 kWh, 3 h discharge time, LS control) non-uniformities exist in the data due to the peak shaving potential of the system. To explain, additional energy storage capacity may not increase the cost savings unless the energy storage capacity exceeds a certain threshold to shave entire peaks at a larger power output.

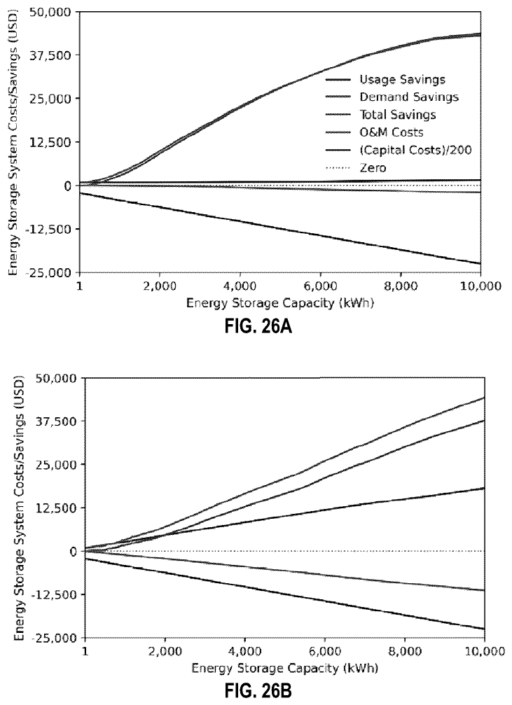

Since E depends on both the capital investment and the total cost savings over the 2-year analysis, a breakdown of costs and savings is presented in FIGS. 26A and 26B for the 8 h discharge time Li-ion BESS under A) PC control and B) LS control. In FIG. 26A it is observed that the demand savings account for most of the total savings, which is expected due to the PC control strategy targeting demand reduction. As such, the usage savings and operation and maintenance costs are relatively small across all energy storage capacities, but there is a point when the demand savings exceed the total savings due to operation and maintenance costs becoming large enough without a significant increase in usage savings. This is due to the billed peak demand occurring during off-peak usage rate hours. In FIG. 26B it is observed that the LS control strategy results in more usage savings, along with more operation and maintenance to achieve these savings. For example, at 5,000 kWh, demand and usage savings make up 96.5% and 3.5% of the total savings, respectively, under PC control. Conversely, at the same energy storage capacity, the LS control strategy's demand and usage savings account for 62.2% and 37.8% of the total savings, respectively.

TABLE 2-2
Optimal energy storage capacity and ∈ for each discharge
time and control strategy (without DR enrollment).

| Discharge time | Control | Energy Storage Capacity (kWh) | ∈ |
|---|---|---|---|
| 1 | PC | 4,819 | 0.0036 |
| 1 | LS | 643 | 0.0076 |
| 2 | PC | 4,819 | 0.0059 |
| 2 | LS | 1,567 | 0.0095 |
| 3 | PC | 4,940 | 0.0075 |
| 3 | LS | 2,651 | 0.0102 |
| 4 | PC | 5,020 | 0.0087 |
| 4 | LS | 4,659 | 0.0110 |
| 8 | PC | 5,020 | 0.0113 |
| 8 | LS | 9,678 | 0.0098 |

2-3.2 Optimal Peak Clipping and Load Shifting Control Strategies Results with DR Enrollment

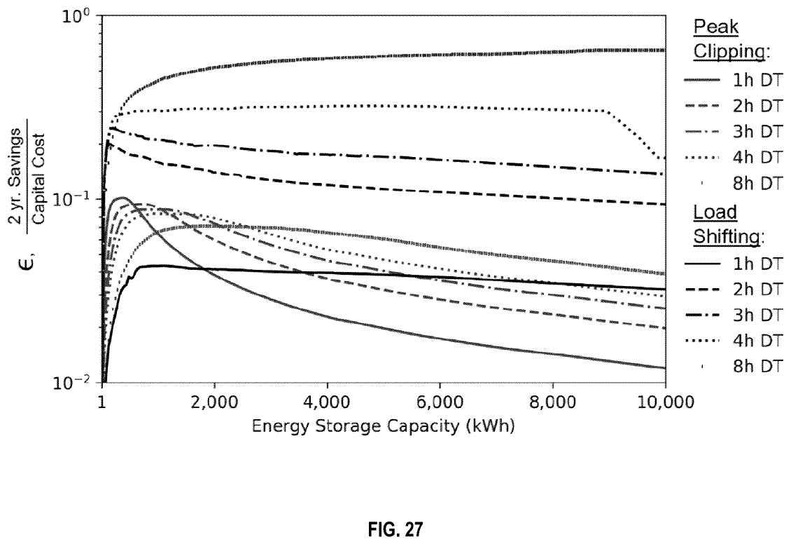

FIG. 27 shows the variation in E as a function of energy storage capacity with event-based DR enrollment. For the 2 h and 3 h discharge times, the optimal energy storage capacity from the PC control strategy is larger than the optimal capacity from the LS control strategy, which agrees with most of the results from the study without event-based DR enrollment. For example, at a 2 h discharge time, the PC control strategy's optimal energy storage capacity is 763 kWh opposed to the LS control strategy's 121 kWh optimal capacity. However, for the 1 h, 4 h and 8 h discharge time cases, the LS control strategy's optimal energy storage capacity is larger than that of the PC control strategy, similar to the 8 h discharge time results from the study without event-based DR enrollment.

Table (2-3) identifies the maximum E values in FIG. 27 with their associated optimal energy storage capacities. For the PC control strategy, E decreases with an increasing discharge time, contrary to the results without DR enrollment. Longer discharge times correlate to lower power outputs for the same energy storage capacity, so less demand reduction is possible during DR events when the discharge time is increased. Conversely, for the LS control strategy, E increases with an increasing discharge time, due to more LS potential. Similar to the previous results, the trends in the data are generally smooth, but in some regions non-uniformities exist. For example, the Li-ion BESS with 3 h discharge time has a decrease in E at approximately 9,000 kWh because an increase in capacity does not increase the peak shaving potential of the energy storage system. To explain, the 10,000 kWh BESS does not achieve any additional savings when compared to the 9,000 kWh BESS, but it has a 560,504 USD increase in the capital investment. It is observed that E values in Table 2 are significantly higher when compared to E values reported in Table 1 due to the large cost benefits from discharging the battery throughout the 15 DR events in the 2 year analysis. For example, the largest and smallest increases in E with DR enrollment are 6,487% (LS control, 8 h discharge time) and 192% (LS control, 4 h discharge time), respectively, when compared to the results without DR enrollment.

TABLE 2-3
Optimal energy storage capacity and ∈ for each discharge
time and control strategies (with DR enrollment).

| Discharge time | Control | Energy Storage Capacity (kWh) | ∈ |
|---|---|---|---|
| 1 | PC | 362 | 0.1014 |
| 1 | LS | 1,125 | 0.0432 |
| 2 | PC | 763 | 0.0939 |
| 2 | LS | 121 | 0.2000 |
| 3 | PC | 1,125 | 0.0877 |
| 3 | LS | 201 | 0.2443 |
| 4 | PC | 924 | 0.0833 |
| 4 | LS | 4,739 | 0.3214 |
| 8 | PC | 1,848 | 0.0714 |
| 8 | LS | 9,237 | 0.6455 |

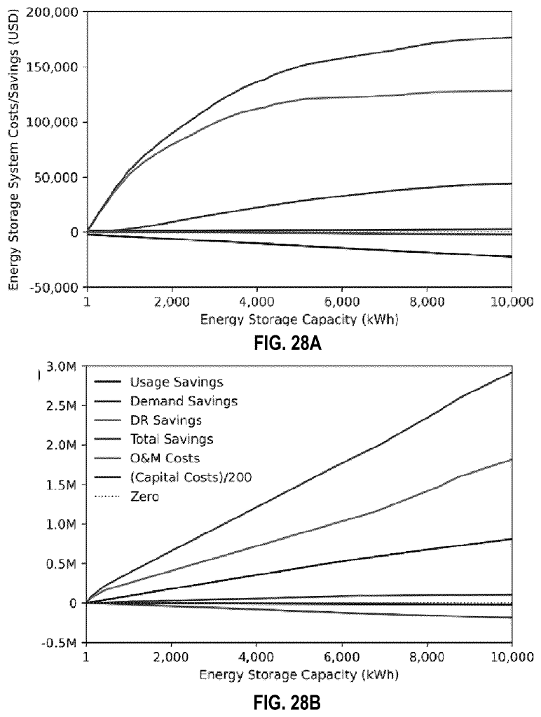

FIGS. 28A and 28B show the costs and savings breakdown of the Li-ion BESS as a function of energy storage capacity for A) PC control and B) LS control with DR enrollment. For both control strategies, it is observed that savings from DR events constitute a larger portion of the total savings compared to the usage and demand savings. For example, at 5,000 kWh, savings from DR events make up 80% and 63% of the PC and LS control strategies' total savings, respectively. In comparison the Demand savings only account for 19% and 5% of the PC and LS control strategies' total savings, respectively, and usage savings make up for 1% and 32%, respectively. It should be noted that the savings under PC control (see FIG. 28A) are significantly less than the savings under LS control (see FIG. 28B) due to the PC control strategy not leveraging the energy-price arbitrage. This is apparent since usage savings are a larger portion of the total savings than demand savings in the LS control strategy.

### 2-3.3 Optimal Peak Clipping and Load Shifting Control Strategies Operations

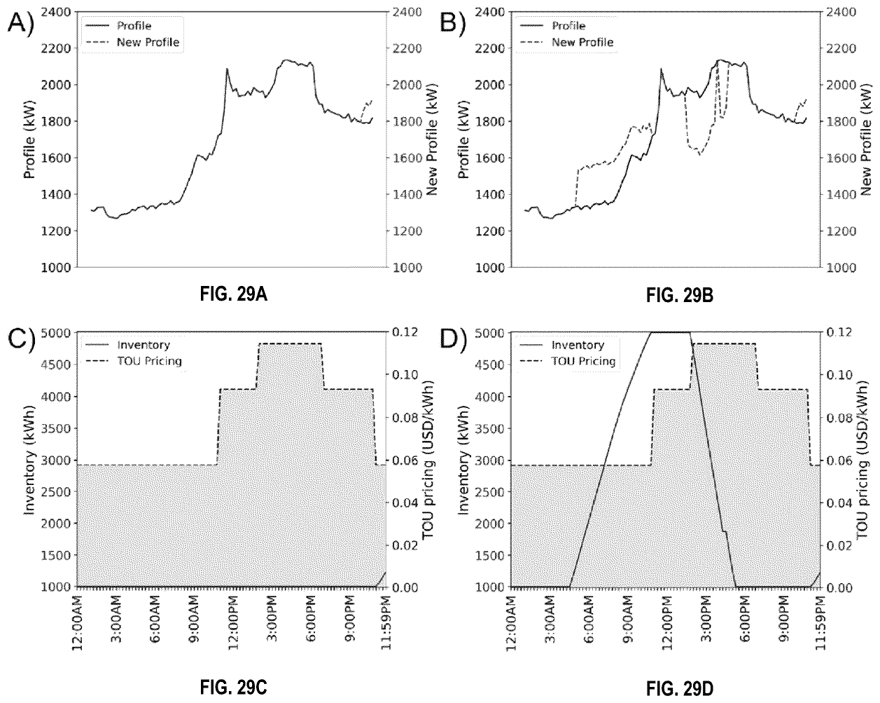

Utilizing the midpoints of the energy storage capacity and discharge time variations, a Li-ion BESS with an energy storage capacity of 5,000 kWh and discharge time of 4 h (maximum power output of 1,250 kW) is selected to compare the PC and LS control strategies with and without event-based DR enrollment in the month of August 2020 (since this month has 4 DR events). The first day in August 2020 with a DR event is plotted in FIGS. 29A-29D, showing the original profile, new profile, energy storage inventory, and TOU pricing for the PC control strategy (see FIGS. 29A and 29C) and the LS control strategy (see FIGS. 29B and 29D). It is clearly seen the PC control strategy does not result in energy storage operation because this day did not have a significant peak demand to shave. However, at the end of the day it can be observed that the system begins to charge during off peak hours. Furthermore, it is seen in the LS control strategy that the BESS is charged when the TOU pricing is low and discharged when the TOU pricing is high, and the same charging at the end of the day is observed between the 2 control strategies. Additionally, it is seen that neither of these control strategies discharge between 6:00 PM and 8:00 PM (during the DR event) due to higher utility costs since these control strategies do not consider event-based DR incentives.

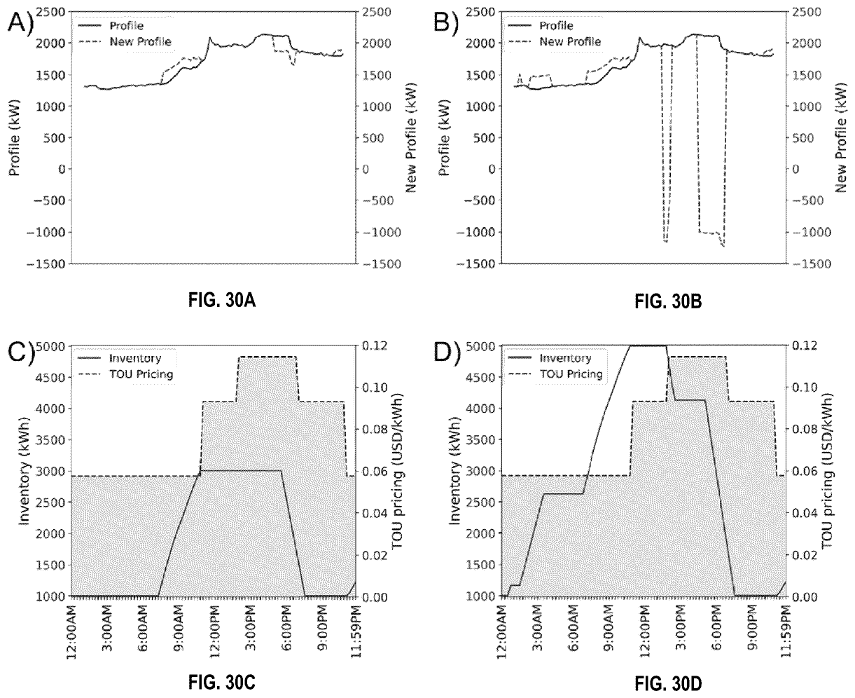

The same 1,250 kW/5,000 kWh Li-ion BESS, with event-based DR enrollment, is optimized and the results are plotted in FIGS. 30A-30D showing A) PC control strategy original and new demand profiles, B) LS control strategy original and new demand profiles, C) PC control strategy inventory and TOU pricing, and D) LS control strategy inventory and TOU pricing. As shown both control strategies reduce the demand during the DR event (6:00 PM to 8:00 PM). However, the LS control strategy reduces the demand so much that net metering occurs (negative demand, sending power back into the electrical grid). In contrast to the PC control strategy operation without DR enrollment in FIG. 29A, FIG. 30A shows charging during off-peak hours and discharging throughout the DR event. However, both cases of the PC control strategy do not leverage the energy-price arbitrage for LS. Conversely, FIGS. 29B and 30B for the LS control strategy operations show that the energy-price arbitrage is taken advantage of to increase the cost savings. However, FIG. 30B shows less LS because the control strategy reserved some energy storage capacity to discharge throughout the DR event.

### 2-3.4 Discounted Payback Period Analysis

The optimal systems (energy storage capacity and discharge time resulting in maximum E), the corresponding capital cost, discounted payback period, and number of BESS replacements required to recover the capital investment for each control strategy with and without DR enrollment are summarized in Table (2-4). As shown the optimal 1,155 kW/9,237 kWh Li-ion BESS from the LS control strategy with DR enrollment quickly pays back in 2.75 years due to its large energy storage capacity, discharge time, and resulting power capacity leading to high TCS from daily LS and DR incentive payouts.

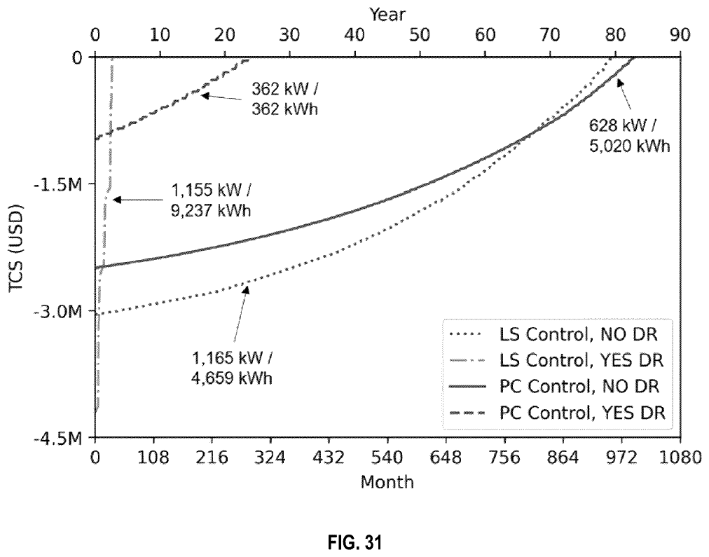

The TCS over the discounted payback period are plotted in FIG. 31 for the optimal sized BESS displayed in Table (2-4). Shorter discounted payback periods are expected to correlate to higher E values, but without DR enrollment the LS control strategy pays back faster than the PC model, despite having a lower ϵ value. The reason for this is due to consideration of the increases in utility costs, i.e., in the discounted payback period formulation (see Eq. (3-13)). Although the 1,165 kW/4,659 kWh optimally sized Li-ion BESS under LS control has a larger capital investment (and lower ϵ value), over a long time the more frequent operation (and resulting savings) causes this system to have a shorter discounted payback period. When DR enrollment is considered, the largest energy storage capacity (9,237 kWh) with a long discharge time (8 h) and high power output (1,155 kW) yields the fastest discounted payback period due to leveraging the energy-price arbitrage, having a large peak shaving potential, and discharging throughout entire DR events.

Clearly, event-based DR incentives can significantly impact the discounted payback period of energy storage systems installed for large electricity consumers. For example, consideration of event-based DR enrollment results in the discounted payback period of the optimal Li-ion BESS under PC control reducing from 86.58 years to 24.75 years with a much lower energy storage capacity and power output. Furthermore, consideration of event-based DR enrollment with the LS control strategy for the optimal Li-ion BESS results in the discounted payback period decreasing from 83 years to 2.75 years with a larger energy storage capacity and comparable power output. The optimal LS control strategy with DR enrollment yields a very fast discounted payback period (2.75 years) for a large Li-ion BESS (1,155 kW/9,237 kWh). Therefore, large electricity consumers enrolled in event-based DR with Li-ion BESSs under the optimal LS control strategy have significant cost saving opportunities while simultaneously contributing to power grid reliability through DR.

### 2-3.5 Discounted Payback Period Sensitivity

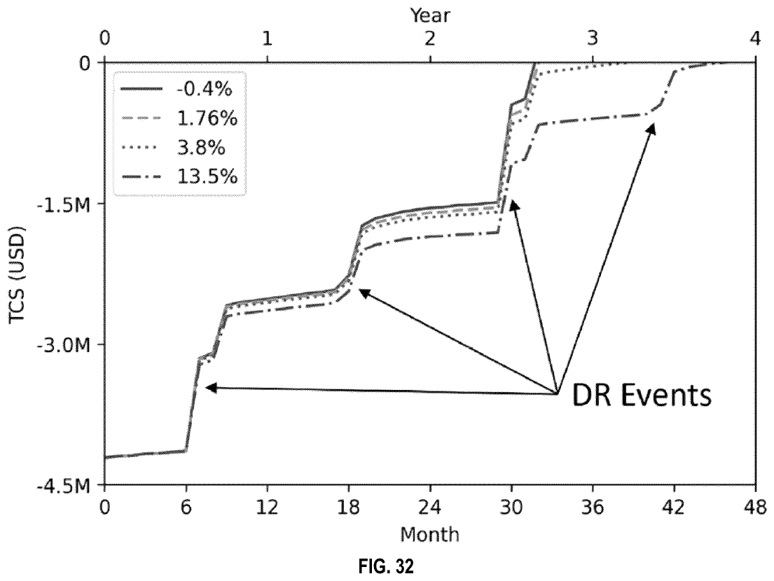

Since the rate of inflation, the utility cost increases, and operation and maintenance cost increases are not likely to remain constant throughout an analysis spanning many years, these parameters are varied to determine the impact on the discounted payback period. The analysis is conducted for the 1,155 kW/9,237 kWh Li-ion BESS under LS control with event-based DR enrollment, since this situation corresponds to the largest economic benefits. As such, the rate of inflation is varied between −0.4% and 13.5%, the lowest and highest annual inflation rates in the United States, respectively, between 1960 and 2021. The original 1.76% inflation rate was the value between 2018 and 2019. The average rate of inflation between 1960 and 2021 was 3.8%. Therefore, FIG. 32 shows the sensitivity of −0.4%, 1.76%, 3.8%, and 13.5% inflation rates on the discounted payback period. As expected, lower inflation rates correlate to faster discounted payback periods. However, even with a high inflation rate of 13.5%, a relatively fast discounted payback period of <4 years (47 months) is realized. Although the discounted payback period is short, inflation has a significant impact on the discounted payback period since the minimum and maximum discounted payback period are 33 and 47 months, respectively, a 35% difference. FIG. 32 also shows the effect of DR enrollment, since the summer months (months with DR events) have very high TCS, whereas the TCS in other months are relatively small.

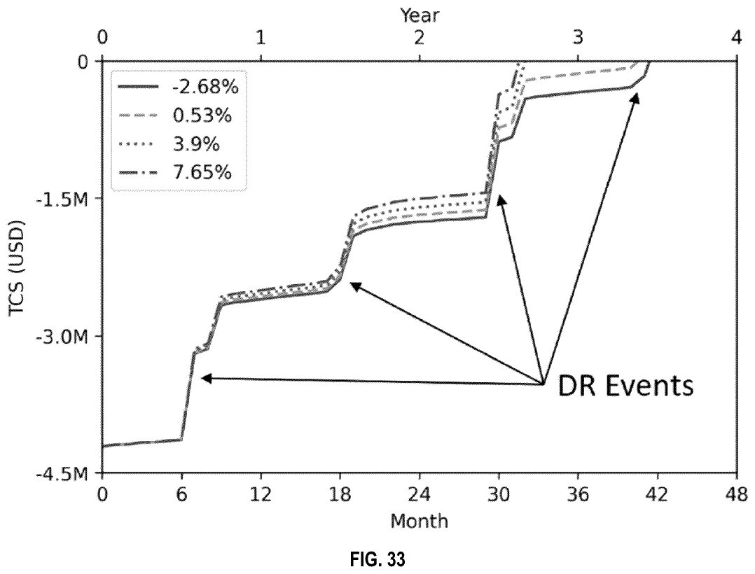

A sensitivity analysis was conducted for the utility cost increase rates. The original utility cost increase rate of 3.9% corresponds to the increase observed between 2020 and 2021 in the industrial sector. However, the average annual utility cost increase in the industrial sector between 2011 and 2021 was 0.53%. The maximum and minimum annual utility cost increases in the industrial sector between 2011 and 2021 are 7.65% and −2.68%, respectively. As such, the utility cost increase rates are varied and plotted in FIG. 33, and the results show that larger utility cost increases result in shorter discounted payback periods. However, like the sensitivity analysis for inflation rate, the minimum utility cost increase still yields a discounted payback period under 4 years (43 months) due to the high TCS of the optimally sized Li-ion BESS under LS control with DR enrollment. Utility cost increases significantly impact the discounted payback period since the highest utility cost increase yields a discounted payback period of 33 months whereas the smallest utility cost increase yields a discounted payback period of 43 months. Therefore, a 26% difference in the discounted payback period is observed due to the variation in this parameter.

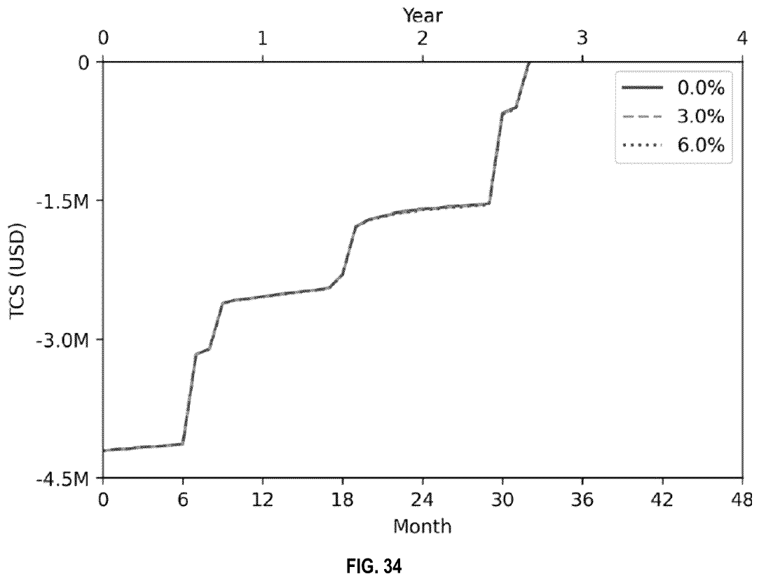

To determine the sensitivity of the discounted payback period to the operation and maintenance cost increases, they are neglected (0%), set at the original value of 3%, and doubled (6%) in an updated analysis. FIG. 34 shows that operation and maintenance cost increase has no noticeable impact on the discounted payback period of an optimally sized Li-ion BESS. This is apparent because the operation and maintenance costs are small compared to the TCS resulting from leveraging the energy-price arbitrage, reducing the billed peak demand, and event-based DR benefits. Therefore, increases in operation and maintenance costs do not significantly impact the discounted payback period of an optimally sized Li-ion BESS under load shifting control with DR benefits.

TABLE 2-4
Optimal energy storage capacities, ∈ values, discharge times,
discounted payback periods, and number of replacements for PC and
LS control strategies with and without event-based DR enrollment.

| | DR | Energy | | discharge | Capital Cost | discounted | |
|---|---|---|---|---|---|---|---|
| Control | enrollme | Storage | ∈ | time (h) | (USD) | payback | Replacements |
| PC | NO | 5,020 | 0.0087 | 8 | 2,491,658 | 86.58 | 1 |
| LS | NO | 4,659 | 0.0110 | 4 | 3,045,684 | 83.0 | 4 |
| PC | YES | 362 | 0.1014 | 1 | 973,704 | 24.75 | 0 |
| LS | YES | 9,237 | 0.6455 | 8 | 4,211,183 | 2.75 | 0 |

Fast capital recovery periods are observed in this study with enrollment in event-based DR (<5 years). This study shows a minimum discounted payback period of 2.75 years whereas another study shows a static recovery period of 4.5 years. A faster capital recovery in this disclosure can be partially attributed to accounting for the time value of money, differences in optimization modelling, and differences in input data. Both studies agree that enrollment in event-based DR results in significantly greater revenue and shorter capital recovery durations. As such, event-based DR should be considered in future studies.

The optimization of control strategy and discharge time shows that the optimally sized Li-ion BESS with the largest capital investment (1,155 kW/9,237 kWh) yielded the fastest discounted payback period (2.75 years) under LS control with DR enrollment due to its LS potential, PC potential, and ability to discharge throughout entire DR events. Furthermore, without event-based DR enrollment, the optimally sized Li-ion BESSs have unreasonably long discounted payback periods (greater than 80 years), so consideration of event-based DR incentives is necessary in Li-ion BESS planning.

The optimally sized Li-ion BESS's discounted payback period (under LS control with DR enrollment) is sensitive to the inflation rate (35% difference in discounted payback period when inflation is varied between −0.4% and 13.5%) and utility cost increases (26% difference in discounted payback period when utility cost increases are varied between −2.68% and 7.65%). However, the discounted payback period is not sensitive to operation and maintenance cost increases due to the relatively short amount of time needed to recover capital costs (<3 years).

### 6. Considering Environmental Impact as a Cost

### 6-1. Introduction

The energy sector accounts for three-quarters of global emissions. In particular, buildings and the construction sector represented 39% of global emissions in 2018, whereas the industry sector made up 24% of global emissions in 2020. Building carbon emissions are primarily associated with the use phase and a significant portion coincides with emissions from the energy sector. Hence, these emissions are considered indirect emissions from energy, or emissions that occur off-site at power generation plants.

Indirect emissions reduction is the focus of this embodiment, rather than the direct emissions that occur on-site at buildings and industrial facilities (e.g., natural gas combustion for heating). The amount of indirect emissions from electricity can be evaluated utilizing marginal emissions factors (MEFs), which quantify the mass of CO₂ emitted per unit electricity generation. MEF values are constantly fluctuating as a result of fluctuating demand on the power grid. As an example, the maximum MEF for a region in the Southwest United States power grid in February 2021 was 56% greater than the minimum MEF value in the same month. Although significant variation exists in MEF values, few studies use time varying MEF values when evaluating indirect emissions from buildings.

Buildings and industrial facilities can reduce their direct emissions by electrifying their fossil fueled equipment, but this comes with increased electricity consumption and therefore increased indirect carbon emissions. Energy efficiency and on-site renewable energy systems are commonly revered as methods for building decarbonization, but energy storage systems (ESSs) are less commonly recognized as a decarbonization strategy. Therefore, many studies explore ESSs integrated in hybrid energy systems rather than stand-alone ESSs. In fact, one research group evaluated Australia's electricity grid and discovered that high MEF values were occurring in the night (times of low electricity demand) and low MEF values occurred during peak demand. As such, they determined ESSs cannot be operated to simultaneously minimize costs and indirect CO₂ emissions in Australia. However, the study herein shows Li-ion battery energy storage systems (BESSs) can be utilized for both decarbonization and cost savings in the Southwestern United States.

Demand response (DR) programs are recognized as a part of decarbonization strategies. There exist both price-based and event-based DR programs. Price-based DR programs are characterized by daily, weekly, and/or seasonal variations in on-peak and off-peak electrical usage rates (i.e., time-of-use pricing). Buildings can leverage this energy-price arbitrage daily with an ESS under a load shifting control strategy (shifting demand from on-peak to off-peak hours). In event-based DR programs, utility companies provide financial compensation to specific electricity consumers for curbing their demand during times of high demand (e.g., often on the highest temperature days of the year in the Southwestern United States). Buildings can use a peak clipping control strategy to reduce the demand charge, and to discharge during DR events—an alternative control strategy to load shifting.

While several studies of hybrid energy systems have explored the cost and indirect CO₂ emission reductions, they omitted the time dependence of MEF values. For example, one group evaluated the techno-economics and emissions impacts of hybrid energy systems (ground source heat pump, photovoltaics, and BESSs) installed at 16 residential dwellings. They found an 80% reduction in greenhouse gas emissions over a 30-year lifetime, but this study used an average MEF value that does not account for time-of-use. Another group developed a multi-objective optimization algorithm to simultaneously minimize electricity costs and emissions of residential microgrids utilizing plug-in hybrid electric vehicles, battery, and thermal energy storage. This study provided battery and thermal energy storage configurations to balance electricity costs and emissions, but omitted time dependent MEF values. Another research team created a residential multi-objective optimization model to design an integrated energy system for minimizing economic, technical, and environmental objectives, but used a constant MEF value. One team developed a multi-objective optimization model to reduce utility costs and indirect CO₂ emissions in a residential application. This study utilized approximated time-dependent MEFs and found that the household could achieve significant cost savings without a significant increase in indirect CO₂ emissions in some regions of the United States. Although a stand-alone BESS was analyzed, this study optimized over only one week of electrical demand and MEF data and recommended that an entire year of data should be analyzed to account for seasonal differences in electricity consumption and MEFs.

Many studies of hybrid energy systems have been published for the residential sector, while other sectors have not been explored sufficiently. One group conducted a case study for a nursing home considering many technologies (including batteries, fuel cells, photovoltaics, combined heat and power, and reciprocating engines) with two strategies as the objective function: minimizing energy costs or CO₂ emissions. This study used two single objective functions, omitted time-dependent MEF values, and showed that minimizing CO₂ emissions can be cost prohibitive. Another group utilized HOMER software to optimize a hybrid energy system consisting of photovoltaics, wind, diesel, and a BESS applied at a remote village community in Bangladesh. Although they considered the direct emissions from the energy systems, they did not consider the indirect CO₂ emissions from power generation plants.

There is a lack of research studies that explore decarbonization of large electricity consumers (e.g., commercial buildings and industrial facilities) while simultaneously achieving cost benefits using stand-alone ESSs. As such, the study presented herein evaluates cost and indirect CO₂ emissions savings of stand-alone BESSs in ten commercial and industrial facilities. Two BESS control strategies (peak clipping and load shifting) with and without enrollment in the utility company's event-based demand response (DR) program are assessed.

### 6-2. Methodology

This section outlines the classifications and demand data of the ten commercial and industrial facilities and explains the optimization methodology and discounted payback period (DPP) methodology. The optimization and DPP methodologies are used to determine the maximum indirect CO₂ emissions savings and minimum DPP.

### 6-2.1 Facility Classifications and Demand Data

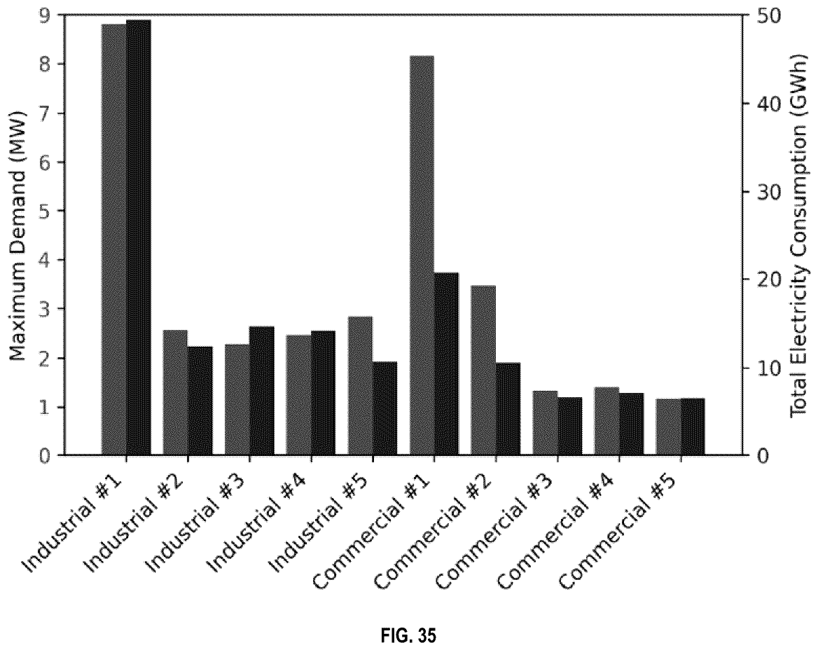

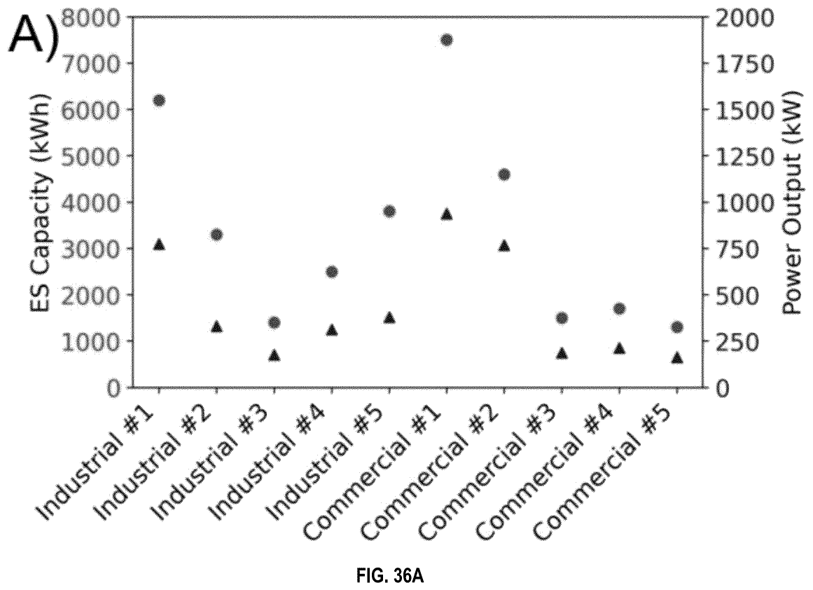

The ten commercial and industrial facilities are described by their North American Industry Classification System (NAICS) numbers, utility pricing structures, and maximum annual demand and electricity consumption in 2021. When broadly classifying these facilities, manufacturing NAICS sectors are considered “industrial” and all others are considered “commercial”. Each of these ten facilities follow one of two utility pricing models, namely “rate plan #1” and “rate plan #2”. Rate plan #1 considers weekends as off-peak usage rates, whereas rate plan #2 considers the weekday time-of-use rate structure on the weekends. However, rate plan #2 has less expensive demand charges and time-of-use pricing structures in all seasons. These facilities' NAICS sectors and rate plans are summarized in Table (4-1) and their maximum peak demand and total electricity consumption in 2021 are plotted in FIG. 35. As shown, Industrial #1 has both the highest maximum annual demand and annual electricity consumption, but Commercial #1 has the highest maximum annual demand to total annual electricity consumption ratio. Additionally, Commercial #5 has the lowest maximum annual demand and annual electricity consumption, but Industrial #3 has the lowest maximum annual demand to total annual electricity consumption ratio.

TABLE 4-1
Ten commercial and industrial facilities'
NAICS sector and utility pricing structures

| | | Utility |
|---|---|---|
| Facility | NAICS Sector | Pricing |
| Industrial #1 | Manufacturing | Rate plan #2 |
| Industrial #2 | Manufacturing | Rate plan #1 |
| Industrial #3 | Manufacturing | Rate plan #1 |
| Industrial #4 | Manufacturing | Rate plan #1 |
| Industrial #5 | Manufacturing | Rate plan #1 |
| Commercial #1 | Arts, entertainment, and recreation | Rate plan #2 |
| Commercial #2 | Public Administration | Rate plan #2 |
| Commercial #3 | Health Care and Social Assistance | Rate plan #1 |
| Commercial #4 | Professional, Scientific, and Technical | Rate plan #1 |
| | Services | |
| Commercial #5 | Wholesale Trade | Rate plan #1 |

Due to economic and operational constraints on the electrical power grid, quantifying the MEF of power generation plants at a given time is nontrivial. However, hourly MEF estimates of Arizona power generation plants are provided by the U.S. Energy Information Administration. With the MEF values, the mass of indirect CO₂ emissions can be calculated, and the cost of these emissions is quantified utilizing the social cost of carbon emissions that “can be measured either by the discounted present value of the damages imposed on the economy by the emissions from a tonne of carbon, or by the marginal cost of mitigating those emissions, since on an optimal path these measures must be equal”. The social cost of carbon emissions is estimated to range from 11 USD/ton to 212 USD/ton from 2015 to 2050, and is taken as 0.056 USD/kg (51 USD/ton) for this study, as set by the current administration.

### 6-2.2 Optimization Methodology

The optimal dispatch of a BESS transforms the electrical demand of a facility to provide economic benefits with a reduction in indirect CO₂ emissions. As such the facilities new electricity demand (NDₜ) can be defined using the original demand (Dₜ) and the amount of energy charged and discharged from the BESS in each interval t (ECₜ and EDₜ, respectively), as shown in Eq. (4-1).

$${ND}_{t} = {D}_{t} - {ED}_{t} + \frac{{EC}_{t}}{η} \qquad ( 4 - 1 )$$

Where η describes the round-trip efficiency of the Li-ion BESS (91.45%). This new demand profile is optimized to minimize the sum of utility costs and social cost of carbon emissions (z), as shown in the objective function (Eq. (4-2)).

$$z = {\sum }_{t ∈ T} ( {ND}_{t} {RT}_{t} + {ND}_{t} {MEF}_{t} cC - {CoD}_{t} {ED}_{t} ) + max ( {ND}_{t} ) DC$$

When the CoD parameter is considered to be the operation and maintenance (O&M) costs (Eq. (4-3)), the Li-ion BESS leverages the energy-price arbitrage and shifts electrical load daily from on-peak to off-peak usage rate hours due to the low CoD (load shifting control strategy). However, when the CoD parameter follows Eq. (4-4), the portion of the capital cost (CC) “spent” by discharging a portion of the total energy expected to be discharged in the lifetime (EL) of the Li-ion BESS, the ESS primarily targets demand cost savings by shaving the peak demand (peak clipping control strategy). Eq. (4-4) utilizes continuous compounding over the expected years of lifetime (L) and the discount rate of the investment, r. This formulation considers the expected increase in O&M costs relative to the original O&M cost (O&M₀), o. Conversely, the load shifting control strategy continually considers O&M₀ to keep the BESS operating at its peak performance, and results in load shifting control. Although the discount rate and O&M increases are not considered in the CoD parameter for load shifting control strategy, like the peak clipping control strategy, these parameters are considered in the discounted payback period calculations.

$${CoD}_{t} = O \& {M}_{o} ∀ t ∈ T \qquad ( 4 - 3 )$$

$${CoD}_{t} = \frac{( {e}^{r} - 1 )}{( 1 - {e}^{rL} )} ( \frac{CC}{EL} + O \& {M}_{o} {e}^{ot} {e}^{- rt} ) ∀ t ∈ T \qquad ( 4 - 4 )$$

The objective function shown in Eq. (4-2) operates based on constraints shown in Eqs. (4-5)-(4-10). Eqs. (4-5)-(4-7) relate the electrical energy charged and discharged to the energy storage inventory (EIₜ, the amount of energy stored in time interval t), and the maximum power input and output, PI and PO, respectively. Furthermore, Eqs. (4-8)-(4-10) relate EI to the rated energy storage capacity (CA) and the maximum depth of discharge threshold (DoD), thereby providing boundaries for EI.

$${EC}_{t} - {ED}_{t} = {EI}_{t} - {EI}_{t - 1} \qquad ( 4 - 5 )$$

$${EC}_{t} \leq PI ∀ t ∈ T \qquad ( 4 - 6 )$$

$${ED}_{t} \leq PO ∀ t ∈ T \qquad ( 4 - 7 )$$

$${EI}_{t = 1} = CA \times ( 1 - DoD ) \qquad ( 4 - 8 )$$

$${EI}_{t} \geq CA \times ( 1 - DoD ) ∀ t ∈ T \qquad ( 4 - 9 )$$

$${EI}_{t} \leq CA ∀ t ∈ T \qquad ( 4 - 10 )$$

In the cases where event-based DR is considered, an additional constraint (Eq. (4-11)) is added to ensure the Li-ion BESS discharges at its maximum power output (PO) during the DR events to maximize the savings. The DR events occurred in the evenings on the 7 highest temperature days of 2021 and are 2-3 hours in duration. For the 2 h discharge time BESS and a 3 h demand response event, the BESS discharges at ⅔ of PO to ensure there is sufficient charge to reduce the demand for the entire 3 h demand response event. Curbing demand during DR events is incentivized at 40 USD/kW reduction and 0.09 USD/kWh.

$${ED}_{t} = PO ∀ t ∈ {T}_{DR} \qquad ( 4 - 11 )$$

The linear objective function and constraints were programmed in the Python 3 package, Pyomo. Furthermore, no optimality gap was passed to the GLPK solver to ensure optimal solutions were achieved

### 6-2.3 Discounted Payback Period (DPP) Methodology

DPP measures the economic performance of an investment by determining the amount of time it takes to recover the capital cost. This formulation considers the time value of money by using historical data to discount future cash flows. To calculate the DPP of the BESS investment, the total cost savings in each month (TCSₘₒ) are calculated using Eq. (4-12) since demand charges are billed monthly. This formulation accounts for the electrical usage cost savings, demand cost savings, and the event-based DR savings (DRS), while accounting for the cost of using the system (CoD term).

$$( 4 - 12 )$$

$${TCS}_{mo} = {\sum }_{t ∈ mo} ( ( {D}_{t} - {ND}_{t} ) {RT}_{t} - {ED}_{t} {CoD}_{ct} ) + [ max ( {D}_{t} ) - max ( {ND}_{t} ) ] DC + DRS$$

The discounted payback period is determined by tracking the total cost savings of the BESS investment (TCS). First, TCS is initialized to the negative of its capital cost (Eq. (4-13)). Since costs are projected to decline from 14-38% by 2025, 28-58% by 2030, and 28-75% by 2050, the lowest values in the Li-ion installed cost ranges for the capital costs per unit power output (CPC) and capital storage costs (CSC) are considered. Furthermore, the fixed cost of a Li-ion BESS investment (FC) is considered. An important assumption in this analysis is that degradation in the BESS power output and energy storage capacity are counteracted by the O&M costs. After initializing the TCS to the negative of the capital cost, the TCS is tracked until it is positive using Eq. (4-14). Since BESS investments tend to operate many years before paying back, the increases in utility costs (i.e., 3.9% annually), increases in O&M costs (3% annually), and inflation (i.e., 1.76%) are considered in this formulation to account for predicted market trends. However, it is also assumed that the BESS is paid in full, so there is no discount rate on a loan.

$$TCS = - 1 [ ( PO ) ( CPC ) + ( CA ) ( CSC ) + FC ] \qquad ( 4 - 13 )$$

$$TCS = {\sum }_{mo} \frac{{{TCS}_{mo} ( 1 + {i}_{e} )}^{\frac{mo}{12}} - O \& {M ( 1 + o )}^{\frac{mo}{12}}}{{( 1 + i )}^{\frac{mo}{12}}} \qquad ( 4 - 14 )$$

### 6-3. Results and Discussion

### 6-3.1 Optimal Sizing Analysis

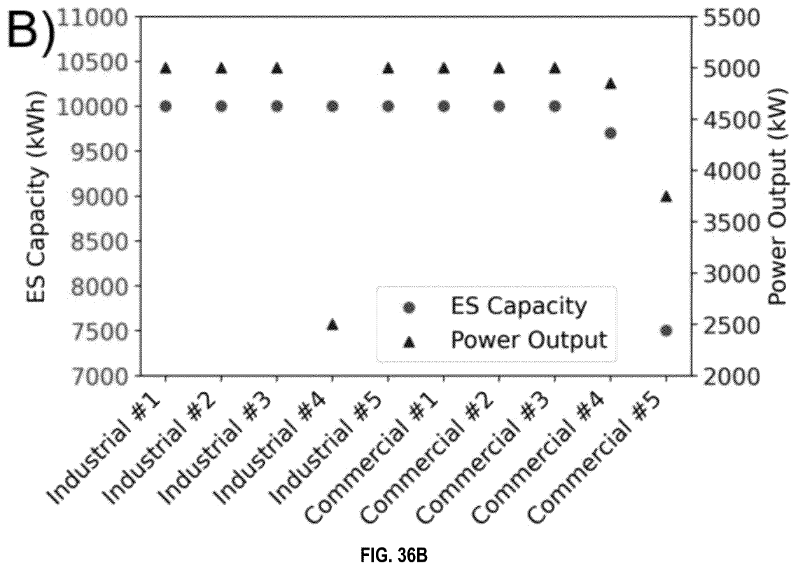

In this section, the optimal ES capacities and power outputs (ES capacity divided by discharge time) are compared across the ten facilities. For each facility there exists an optimal ES capacity and power output that minimizes the DPP, and there is another optimal ES capacity and power output that maximizes the percentage of indirect CO₂ emissions saved (CO2S). In some facilities there are multiple ES capacities and power output combinations that result in the same DPP, so the ES capacity and power output with the lowest capital cost is considered optimal. The optimal ES capacities and power outputs for minimizing DPP and maximizing CO2S are shown in FIGS. 36A and 36B, respectively. FIG. 36A shows Industrial #1, Commercial #1 and #2 are among the largest optimally sized BESSs (in power output and ES capacity) when the optimal DPP is the only objective. Considering FIG. 35 and Table (4-1), these 3 facilities had the highest maximum annual demands and were the only 3 facilities billed under rate plan #2 (weekday time-of-use pricing on the weekends but less expensive demand charges and time-of-use pricing in all seasons).

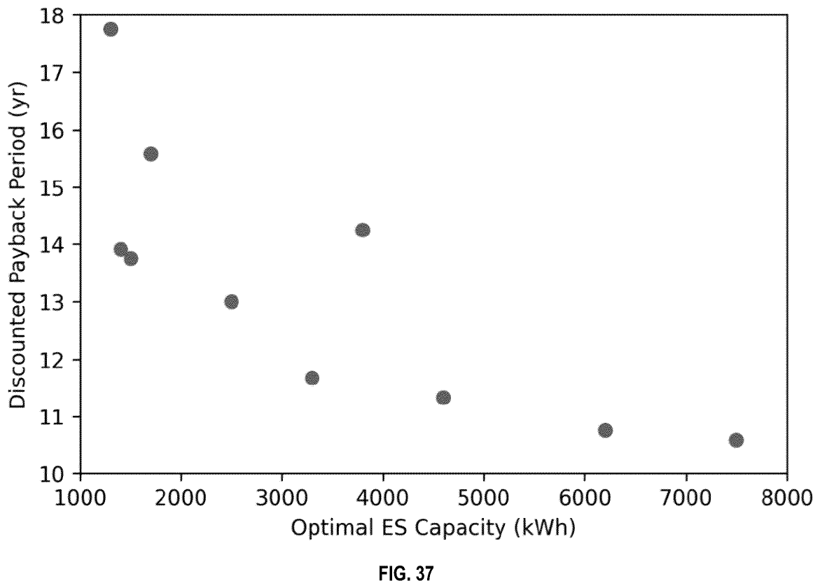

FIG. 37 was generated to observe how the DPP trends with the optimal ES capacity. The results demonstrate smaller optimal ES capacities are correlated with longer DPPs and larger optimal ES capacities result in shorter DPPs. For example, the largest optimal ES capacity, 7,500 kWh, corresponds to the shortest DPP in Commercial #1 (10 years and 7 months). Conversely, the smallest optimal ES capacity, 1,300 kWh, corresponds to the longest DPP of 17 years and 9 months in Commercial #5. Considering the differences in the facilities portrayed in FIG. 35, it is evident that Commercial #1 has the highest maximum demand to total electricity consumption ratio, indicating that this may be related to the large optimal ES sizing and fast DPP. However, Commercial #5 has the lowest maximum demand and total electricity consumption across the ten facilities analyzed, thereby resulting in the smallest optimal ES capacity and longest DPP.

Trends in FIG. 36B show that the optimal ES capacities and power outputs for maximizing indirect CO₂ emissions reduction tend to be the largest size possible, in 7 of the 10 facilities analyzed. This is to ensure the BESS can shift as much demand from times of high MEF values to times of low MEF values. One facility, Commercial #4, had no benefit from increasing its ES capacity from 9,700 kWh to 10,000 kWh or the associated 150 kW power output increase. Furthermore, another facility, Industrial #4, had an optimal sizing of 10,000 kWh, but a power output half that of the 7 facilities that reached an optimal with the maximum power output. Therefore, this facility benefitted from discharging its 10,000 kWh ES capacity over 4 hours rather than 2 hours. The same facility that experienced the smallest optimal ES capacity and longest DPP, Commercial #5, also had the smallest optimal ES capacity for maximizing CO2S. No additional CO₂ savings resulted from increasing the ES capacity from 7,500 kWh to 10,000 kWh since this facility has a consistently low electricity demand, as seen by its maximum demand and total electricity consumption in FIG. 35.Error! Reference source not found.

### 6-3.2 Discounted Payback Period and Carbon Dioxide Emissions Savings

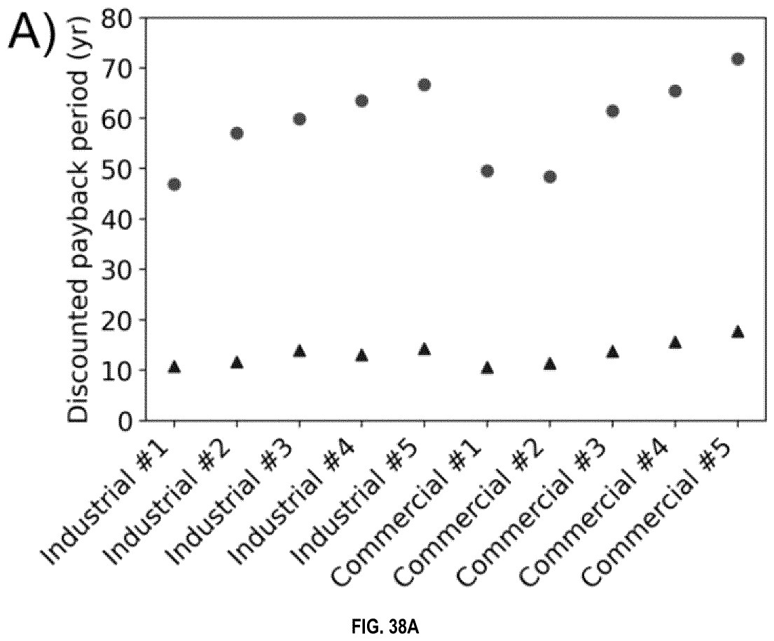

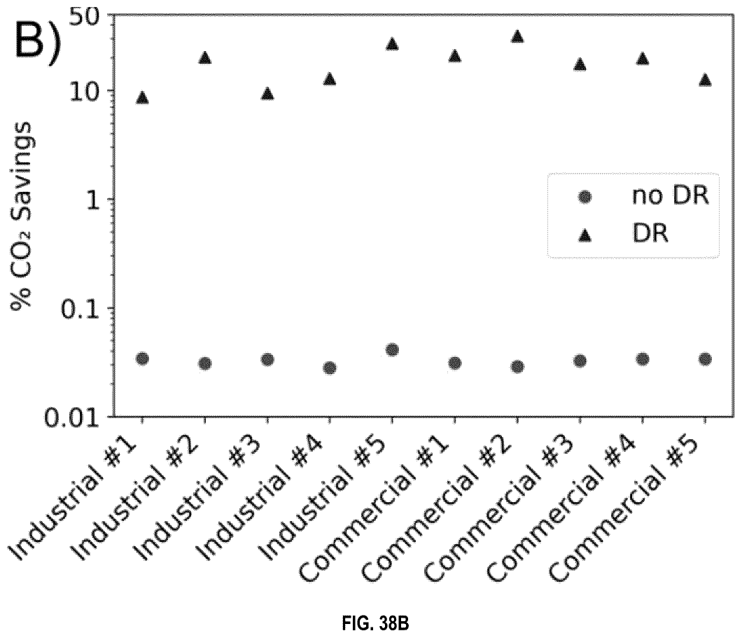

The impact of event-based DR enrollment on the DPP and the CO₂ savings is shown in FIGS. 38A and 38B, utilizing the optimal control strategy, ES capacity, and discharge time with and without DR enrollment. Note, the optimal sizing shown in FIG. 36A was used for calculations in FIG. 38A and optimal sizing from FIG. 36B for FIG. 38B. In FIG. 38A it is seen that the DPP is always faster with enrollment in the event-based DR program, which is intuitive since more revenue is associated with the Li-ion BESS investment by discharging during the event. However, in FIG. 38B it can also be observed that the percentage of indirect CO₂ emissions saved is always higher with enrollment in the event-based DR program. The reason for this is the Li-ion BESS can capitalize on DR events to generate a high amount of revenue, while focusing other operations on charging when the carbon intensity of the grid is low, and discharging when it is high. To summarize, event-based DR enrollment benefits both objectives of this optimization: minimizing the facilities utility costs (and therefore DPP) and minimizing indirect CO₂ emissions.

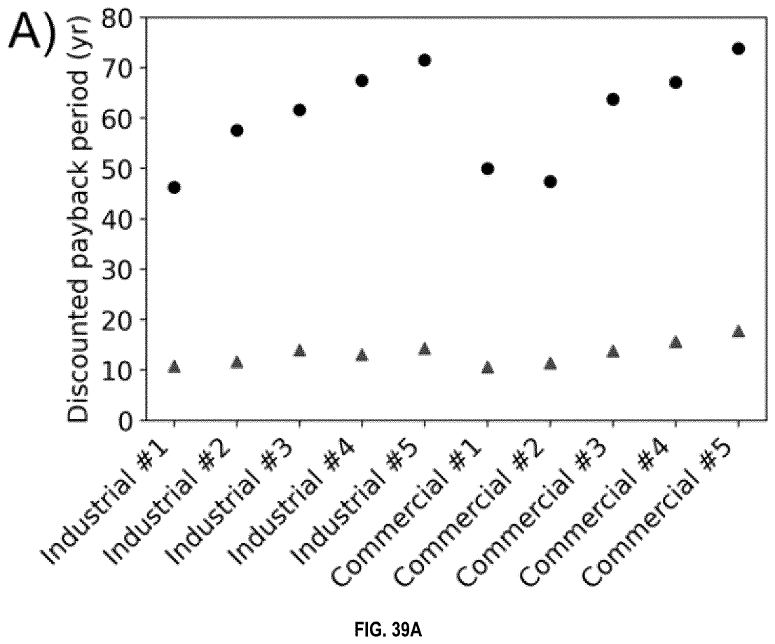

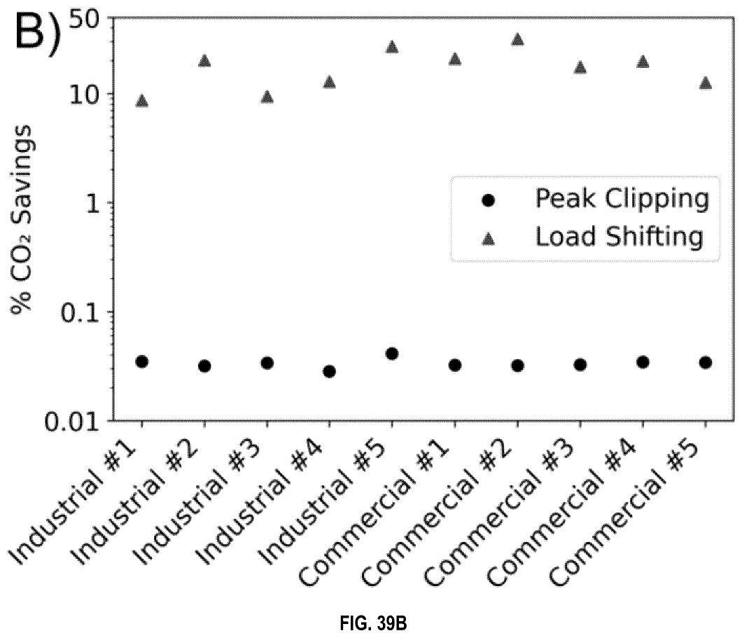

The impact of the control strategy on the DPP and CO2S is shown in FIGS. 39A and 39B. Recall the load shifting control strategy tends to shift electricity demand daily from on-peak to off-peak hours, whereas the peak clipping control strategy tends to target the facility's billed peak demand. The results shown in FIGS. 38A and 38B without DR enrollment and the results shown in FIGS. 39A and 39B under the peak clipping control strategy trend similarly, whereas the results with DR enrollment (in FIGS. 38A and 38B) and the results under the load shifting control strategy (in FIGS. 39A and 39B) trend similarly. For example, in Commercial #1, the minimum DPP without DR enrollment under load shifting control is 5 months faster than the DPP with DR enrollment under peak clipping control (49 years and 6 months compared to 49 years and 11 months). However, the maximum CO₂ savings without DR enrollment is 0.031% (under load shifting control, see FIGS. 38A and 38BError! Reference source not found.) and under peak clipping control is 0.032% (with DR enrollment, see FIGS. 39A and 39B). Clearly, it is always optimal for these 10 commercial and industrial facilities to enroll in event-based DR and operate under the load shifting control strategy.

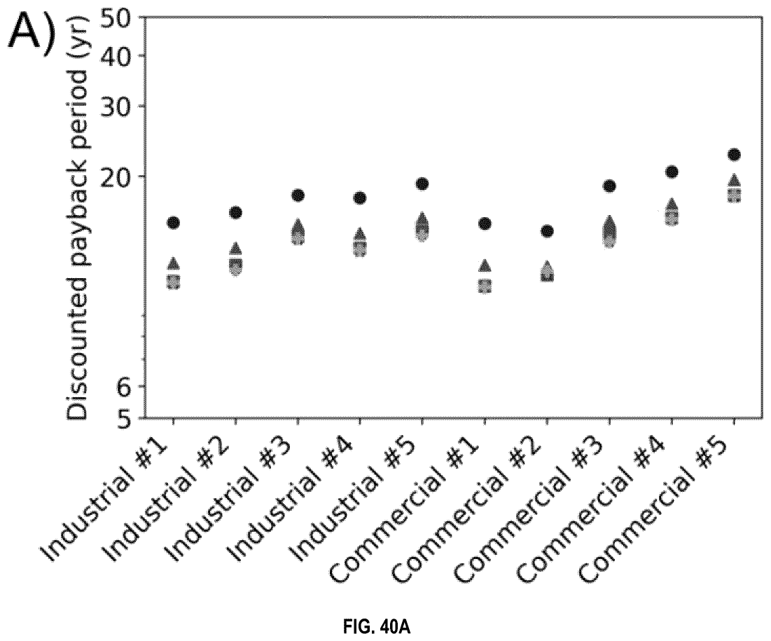

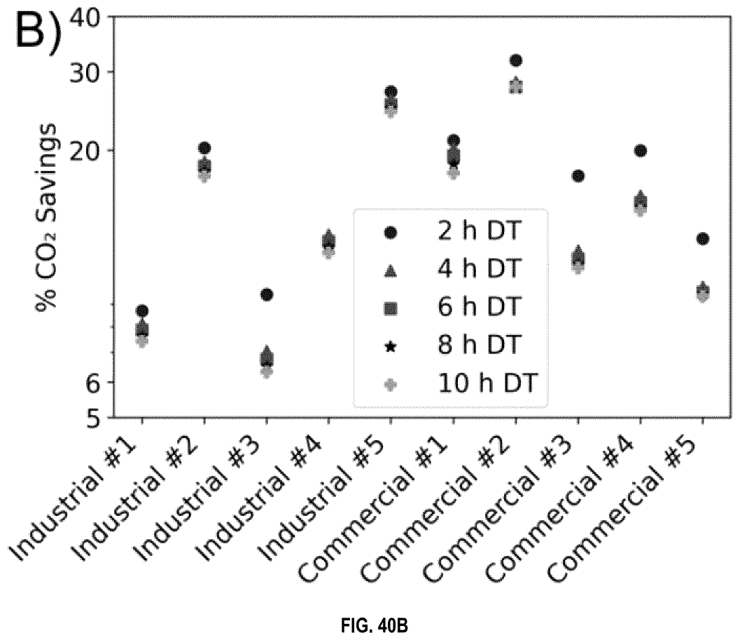

Utilizing the optimal cases with DR enrollment and load shifting control, the minimum DPP and maximum CO₂ savings are plotted in FIGS. 40A and 40B, respectively, for each discharge time tested. FIG. 40A shows that the DPP is minimized with an 8 h or 10 h discharge time in all facilities. In Industrial #2 and #5, the 10 h discharge time yielded a shorter DPP while in Industrial #1, #3, #4, and Commercial #2 and #5, the 8 h discharge time yielded a shorter DPP. Interestingly, in Commercial #1, #3, and #4, the 8 h discharge time and 10 h discharge time resulted in the same DPP. For example, in Commercial #1, the 8 h discharge time and 10 h discharge time yielded the same minimum DPP of 10 years and 7 months. However, the 8 h discharge time utilizes an optimally sized 7,500 kWh Li-ion BESS, whereas the 10 h discharge time utilizes an optimally sized 9,600 kWh Li-ion BESS. Although the 9,600 kWh/10 h discharge time BESS required an additional 567,317 USD capital investment, it also yielded 44,177 USD more cost savings in 2021 due to its higher power output capability (960 kW vs. 937.5 kW). Regarding CO₂ savings, a 2 h discharge time was optimal in all facilities, except Industrial #4, where a 4 h discharge time was optimal. Furthermore, the largest ES capacity tested, 10,000 kWh, was optimal in all facilities except Commercial #4 and #5, where 9,700 kWh and 7,500 kWh, respectively, were optimal. The short discharge times with large ES capacities allowed the system to charge at high power when MEF values were low, and discharge at high power when MEF values were high, therefore shifting large amounts of energy and CO₂ emissions in short durations.

### 6-3.3 Optimal Dispatch Control Strategies

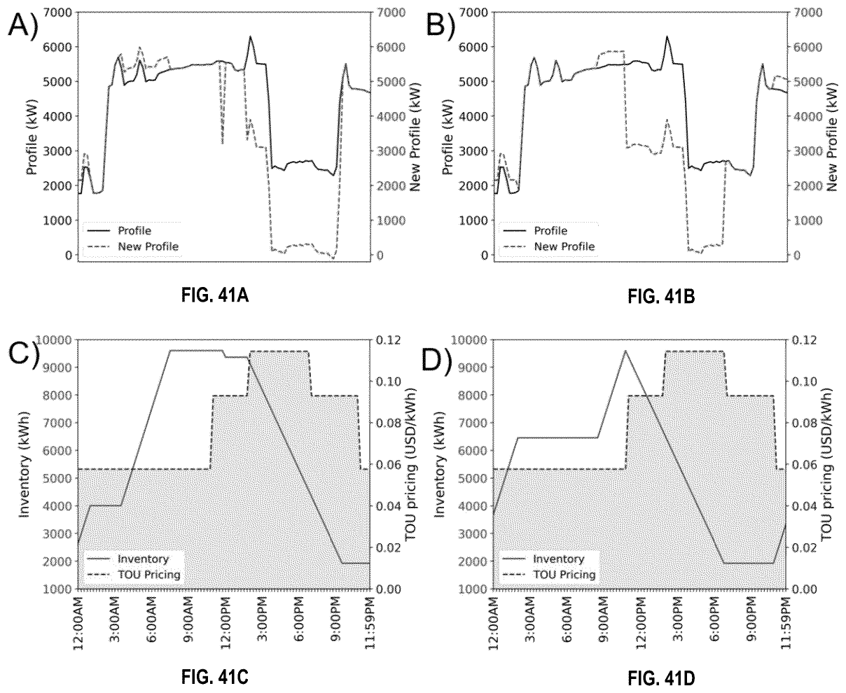

Since Commercial #1 had the shortest DPP, the operation of the optimally sized system under the optimal control strategy (load shifting) is shown in FIGS. 41A-41D for a day in August with a DR event from 4:00 P.M. to 7:00 P.M. FIG. 41A shows the original and new demand profiles and FIG. 41C shows the charge stored in the BESS (inventory) and the associated time-of-use (TOU) electricity pricing under the multi-objective optimal control strategy. FIG. 41B shows the original and new demand profiles and FIG. 41D shows the inventory and the associated TOU electricity pricing under a cost only load shifting optimization strategy, with enrollment in event based DR (optimal control model). Although the 8 and 10 h DTs both resulted in a 10 year and 7 month DPP, the 10 h discharge time system's (9,600 kWh) dispatch is presented because it resulted in additional CO₂ savings when compared to the 8 h discharge time system (17.1% vs. 14.4%). As shown, the BESS discharges constantly from 2:00 P.M. through approximately 9:00 P.M. in the multi-objective optimization, ensuring the facility's demand is curbed throughout the entire DR event (4:00 P.M. to 7:00 P.M.) for both the multi-objective optimization and the cost objective optimization. In the cost objective optimization, the BESS begins to discharge sooner, but not as late into the evening.

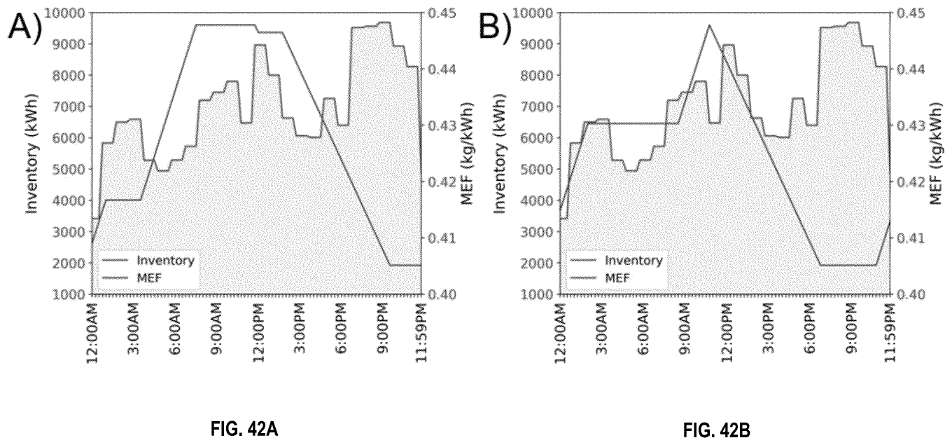

Both optimized operations charge only during off-peak usage rate hours, and discharge during times of higher usage rate hours, but their operations are clearly different. Based on FIGS. 41A-41D alone, it does not appear the BESS should continue to discharge after 7:00 P.M. in the multi-objective optimization case since the DR event is over and the TOU pricing is not at its highest rate. Therefore, FIGS. 42A and 42B were generated to show the same change in ES inventory against the power grid's MEF values for the multi-objective optimization and the cost optimization, respectively. Considering the MEF values it is apparent that the BESS under multi-objective optimization continues to discharge after 7:00 P.M. since the power grid is having very high CO₂ emissions. Furthermore, FIG. 42A explains why the BESS under multi-objective optimization charges at the start of the day (when MEF is low), remains idle (when MEF values increase), and finishes charging while MEF values are lower than their afternoon values. However, in FIG. 42B, the BESS does not take grid MEF values into account when deciding to charge, remain idle, and discharge. Also, in the multi-objective optimization a small amount of discharge is observed, ending at approximately noon, to reduce indirect CO₂ emissions. FIGS. 41A-41D show that this was not necessarily a cost-effective discharge since it did not reduce the peak demand and it was not during the time of highest electrical usage cost. Additionally, FIGS. 42A and 42B helps explain the results in FIG. 40B (i.e., short DTs maximized CO₂ savings), because the BESS needs to shift large amounts of energy (and therefore indirect CO₂ emissions) in the short windows of low and high MEF values.

This study evaluates the decarbonization and cost saving potential of stand-alone BESSs over one year of demand data across 6 NAICS commercial and industrial sectors. Previous studies showed greater amounts of indirect CO₂ emissions when conducting cost only optimization compared to the multi-objective optimization. However, these studies always showed an increase in indirect CO₂ emissions, likely due to the low electricity demand of residential homes. In contrast, the study outlined in this section showed the facility with the smallest average electricity demand also had the smallest optimally sized BESS and relatively low CO₂ savings when compared to other facilities. While the previous work for residential buildings indicates that BESSs cannot be used for decarbonization of indirect emissions, this study shows they can be a strategy for larger energy consumers like commercial and industrial buildings. Large reductions in indirect emissions (>20%) were observed with optimal dispatch strategies.

There is a lack of published research in multi-objective cost and CO₂ emissions minimization from stand-alone BESSs in commercial and industrial electricity consumers. More customers should be analyzed across more NAICS sectors to identify trends within various sectors. Furthermore, additional analyses could be conducted on how the electricity consumption patterns (demand “features”) impact the optimal results. Correlation between demand features and optimal results will help researchers quickly identify facilities that can experience cost benefits with a reduction in indirect CO₂ emissions.

### 6-4. CONCLUSIONS

This study presents optimal ES sizing results and the impact on DPP and CO₂ savings for Li-ion BESSs optimally discharged in ten commercial and industrial facilities with multi-objective cost and CO₂ emissions minimization. Larger optimal ES capacities are correlated to shorter DPPs, and smaller optimal ES capacities are correlated to longer DPPs. For example, the largest optimally sized BESS resulted in the shortest DPP, and the smallest optimally sized BESS resulted in the longest DPP. The facility that had the largest peak demand to average demand ratio resulted in the largest optimally sized BESS, whereas the facility with the smallest average demand of the ten facilities analyzed resulted in the smallest optimally sized BESS. The results indicated that the indirect CO₂ emissions savings were maximized in 7 of the 10 facilities with the largest sized BESS tested (5,000 kW/10,000 kWh). Conversely, the other 3 facilities either did not benefit from the additional ES capacity or the additional power output

The most significant conclusion is that BESSs can be used to decarbonize significant amounts (>20%) of indirect CO₂ emissions for large energy users like commercial and industrial buildings. The impact of enrollment in the event-based DR program, control strategy, and discharge time on the DPP and CO₂ savings were also investigated. The results show that enrollment in the event-based DR program and the load shifting control strategy always resulted in faster DPPs and greater CO₂ savings. Furthermore, it is observed the DPP is minimized with 8 h or 10 h discharge time in all facilities and CO₂ savings is maximized with a 2 h discharge time in all but a single facility

This study shows the multi-objective cost and CO₂ minimization optimal control strategy can be validated by observing the dispatch strategy compared to the cost only optimal control strategy. The dispatch of the multi-objective optimal control strategy ensures the BESS discharges during the DR event, times of high TOU electricity costs, and/or during times of high grid MEF values. On the other hand, the cost objective optimal control policy only discharges during DR events and times of high TOU electricity costs, without consideration of the grid MEF values

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A method, comprising:
accessing power demand data for a facility, the power demand data representing an original demand value for each power demand interval of a plurality of power demand intervals; and
optimizing, based on comparison between a new demand value and the original demand value for each respective power demand interval of the plurality of power demand intervals, a charge-discharge profile of a Battery Energy Storage System (BESS) that results in minimization of a total cost factor over the plurality of power demand intervals.

2. The method of claim 1, the total cost factor incorporating:
an environmental cost factor under the charge-discharge profile of the BESS that quantifies an environmental impact of using the BESS;
an electricity consumption cost factor in terms of the new demand value under the charge-discharge profile of the BESS;
a BESS usage cost factor of using the BESS under the charge-discharge profile of the BESS that quantifies expected degradation of the BESS over time;
a demand cost factor that quantifies an expected utility cost associated with the new demand value under the charge-discharge profile of the BESS; and
a demand response factor that quantifies a benefit associated with event-based demand response enrollment under the charge-discharge profile of the BESS.

3. The method of claim 2, the BESS usage cost factor incorporating continuous compounding over the plurality of power demand intervals.

4. The method of claim 1, further comprising:
iteratively determining the new demand value based on the original demand value for each power demand interval of the plurality of power demand intervals and for the charge-discharge profile of the BESS, the new demand value incorporating an expected discharge amount of the BESS and an expected charge amount of the BESS under the charge-discharge profile; and
evaluating the total cost factor over the plurality of power demand intervals under the charge-discharge profile of the BESS.

5. The method of claim 4, the new demand value subtracting the expected discharge amount of the BESS under the charge-discharge profile from the original demand value for the power demand interval.

6. The method of claim 4, the new demand value adding the expected charge amount of the BESS under the charge-discharge profile to the original demand value for the power demand interval.

7. The method of claim 4, further comprising:
evaluating the total cost factor over the plurality of power demand intervals while varying parameters of the charge-discharge profile of the BESS; and
identifying the charge-discharge profile for the BESS having parameters that result in minimization of the total cost factor.

8. The method of claim 1, the charge-discharge profile of the BESS including:
a set of properties of the BESS;
a usage scheme of the BESS that defines a charge-discharge policy of the BESS; and
an event-based demand response policy of the BESS.

9. The method of claim 8, the set of properties of the BESS including one or more of:
a type of the BESS;
a capacity of the BESS; and
a capacity of the BESS.

10. The method of claim 8, the usage scheme being one of:
a peak-clipping policy where the BESS charges during intervals when the original demand value is below a charge threshold value and where the BESS discharges during intervals when the original demand value is above a discharge threshold value; and
a load-shifting policy where the BESS charges during off-peak usage hours and discharges during on-peak usage hours.

11. The method of claim 1, further comprising:
applying the charge-discharge profile to a control system that operates the BESS according to the charge-discharge profile.

12. The method of claim 1, further comprising:
evaluating a total cost savings factor that quantifies a total difference between costs associated with the original demand value over the plurality of power demand intervals and the total cost factor under the charge-discharge profile of the BESS over the plurality of power demand intervals.

13. The method of claim 12, further comprising:
determining a timeframe in which the total cost savings factor is expected to exceed a total capital cost associated with the BESS under the charge-discharge profile of the BESS over the plurality of power demand intervals.

14. The method of claim 1, further comprising:
displaying, at a display device in communication with a processor, a graphical representation representing the total cost factor.

15. A system, comprising:
a processor in communication with a memory, the memory including instructions executable by the processor to:
access power demand data for a facility, the power demand data representing an original demand value for each power demand interval of a plurality of power demand intervals; and
optimize, based on comparison between a new demand value and the original demand value for each respective power demand interval of the plurality of power demand intervals, a charge-discharge profile of a Battery Energy Storage System (BESS) that results in minimization of a total cost factor over the plurality of power demand intervals.

16. The system of claim 15, the total cost factor incorporating:
an environmental cost factor under the charge-discharge profile of the BESS that quantifies an environmental impact of using the BESS;
an electricity consumption cost factor in terms of the new demand value under the charge-discharge profile of the BESS;
a BESS usage cost factor of using the BESS under the charge-discharge profile of the BESS that quantifies expected degradation of the BESS over time;
a demand cost factor that quantifies an expected utility cost associated with the new demand value under the charge-discharge profile of the BESS; and
a demand response factor that quantifies a benefit associated with event-based demand response enrollment under the charge-discharge profile of the BESS.

17. The system of claim 16, the BESS usage cost factor incorporating continuous compounding over the plurality of power demand intervals.

18. The system of claim 15, the memory including instructions further executable by the processor to:
iteratively determine the new demand value based on the original demand value for each power demand interval of the plurality of power demand intervals and for the charge-discharge profile of the BESS, the new demand value incorporating an expected discharge amount of the BESS and an expected charge amount of the BESS under the charge-discharge profile; and
evaluate the total cost factor over the plurality of power demand intervals under the charge-discharge profile of the BESS.

19. The system of claim 15, the charge-discharge profile of the BESS including:
a set of properties of the BESS including a type of the BESS, a capacity of the BESS, and a capacity of the BESS;
a usage scheme of the BESS that defines a charge-discharge policy of the BESS; and
an event-based demand response policy of the BESS.

20. The system of claim 19, the usage scheme being one of:
a peak-clipping policy where the BESS charges during intervals when the original demand value is below a charge threshold value and where the BESS discharges during intervals when the original demand value is above a discharge threshold value; and
a load-shifting policy where the BESS charges during off-peak usage hours and discharges during on-peak usage hours.
